(19) United States
(12) Patent Application Publication
(10) Pub. No.: US 2014/0071119 A1
(43) Pub. Date: Mar. 13, 2014

(54) Displaying 3D Objects in a 3D Map Presentation

(71) Applicant: APPLE INC., Cupertino, CA (US)

(72) Inventors: Patrick S. Piemonte, San Francisco, CA (US); Billy P. Chen, Santa Clara, CA (US)

(73) Assignee: APPLE INC., Cupertino, CA (US)

(21) Appl. No.: 13/632,027

(22) Filed: Sep. 30, 2012

Related U.S. Application Data
(60) Provisional application No. 61/699,807, filed on Sep. 11, 2012.

(51) Int. Cl. G06T 15/00; G06T 13/00

(52) U.S. Cl. 345/419

(57) ABSTRACT

Some embodiments of the map display application described herein display three-dimensional representations of three-dimensional objects. When the map presentation is moved to display a new area, the three-dimensional representations rise from a ground level to their full heights and transition from transparent to opaque at the same time. The map display applications of some embodiments also remove three-dimensional representations of objects by lowering the objects from their full height to ground level and fading out the representations from opaque to transparent.

### CLAIM OF BENEFIT TO PRIOR APPLICATIONS

This application claims the benefit of U.S. Provisional Patent Application 61/699,807 entitled “Displaying 3d Objects in a 3d Map Presentation,” filed Sep. 11, 2012. The contents of U.S. Provisional Patent Application 61/699,807 are incorporated herein by reference.

### BACKGROUND

Electronic map applications sometimes display more than roads. Some applications display buildings, trees, and/or other features of the landscape. The sheer amount of data involved in displaying a large area of land at a relatively small scale results in map applications that keep a limited amount of map data available at any given time. This data primarily includes the area that the user is looking at at the time. In some map applications, the present location and/or orientation of the map presentation can change at any time at the instruction of the user. It is not always possible to predict where the user will move the map presentation.

When a user moves a map presentation in a map application to a previously unviewed area, the map application may not have data available that would allow it to depict that area. The data may be in a local storage device such as a hard drive, or in a non-local storage such as an external server, but it is not immediately available to the graphics engines of the map application when the application needs to display the area. In prior art map applications, the depiction of the area is carried out as soon as the data becomes available. For example, in a map application that depicts buildings as building representations, the building representations simply pop onto the map as the data defining them is downloaded from a server or retrieved from local storage. Such sudden appearances can be jarring and confusing to the user.

### BRIEF SUMMARY

In some embodiments, a map application adds 3D object representations (e.g., building representations) to a map presentation in a way that is not jarring or sudden. Instead, the application raises and fades in the building representations. That is, the building representations are at first depicted as almost transparent and low (near or at ground level), the buildings are then gradually depicted as more and more opaque and at the same time taller and taller until they reach full opacity and full height. Areas can be brought into view by a command to pan the map, or to zoom in below a threshold level for depicting building representations, or by some other command, in some embodiments.

The building representations are also depicted in a two dimensional (2D) map presentation in some embodiments. In a 2D presentation of some embodiments the buildings are depicted as flat, so they do not rise. However, the map applications of such embodiments fade in the buildings and then cause them to rise if and when the map presentation transitions to a 3D view (e.g., at the command of the user).

In some embodiments, building representations lower and fade out (go gradually from full height to zero height and from full opacity to zero opacity). For example, when a building representation is far from the center of the field of view of a map presentation (e.g., near the horizon) it is removed by being lowered and faded out. Similarly, when the map presentation is zoomed out above a threshold for depicting building representations, the building representations already displayed on the map lower and fade out in some embodiments.

The preceding Summary is intended to serve as a brief introduction to some embodiments described herein. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a process for initially displaying three dimensional representations of buildings in a map application.

FIG. 2 illustrates a map application that applies fade in and rising in a three dimensional mode.

FIG. 3 illustrates a map application of some embodiments displaying buildings fading in in a two dimensional mode.

FIG. 4 conceptually illustrates a process of some embodiments for raising and fading in building representations after zooming in on a map.

FIG. 5 illustrates raising and fading in building representations after zooming in to a threshold level on a map in a 3D map mode.

FIG. 6 conceptually illustrates a process of some embodiments for fading in buildings in a 2D mode.

FIG. 7 illustrates a map application zooming in to the threshold level on a map in 2D mode.

FIG. 8 conceptually illustrates a process of some embodiments for raising opaque building representations after a transition from a 2D map presentation mode to a 3D map presentation mode.

FIG. 9 illustrates transitioning a map presentation from a 2D mode, with opaque building representations, to a 3D mode.

FIG. 10 conceptually illustrates a process of some embodiments for fading in buildings in a 2D mode and raising them after an early transition to a 3D mode.

FIG. 11 illustrates zooming in to a threshold level on a map presentation in a 2D mode then transitioning to a 3D mode while building representations fade in.

FIG. 12 conceptually illustrates a process of some embodiments for removing building representations from part of a 3D presentation of the map.

FIG. 13 illustrates a map application removing building representations in a 3D presentation of the map.

FIG. 14 conceptually illustrates a process of some embodiments for zooming out a 3D presentation of the map of a map application.

FIG. 15 illustrates zooming out a 3D presentation of a map past a threshold zoom level for displaying building representations.

FIG. 16 conceptually illustrates a process of some embodiments for zooming out a 2D presentation of a map.

FIG. 17 illustrates zooming out a 2D presentation of a map past a threshold zoom level for displaying building representations.

FIG. 18 illustrates a process of some embodiments for directing the animation of building representations being added.

FIG. 19 illustrates a process of some embodiments for directing the animation of building representations being removed.

FIG. 20 illustrates a software architecture of some embodiments for adding and removing buildings from map presentations.

FIG. 21 illustrates an example of an architecture of a mobile computing device.

FIG. 22 conceptually illustrates another example of an electronic system with which some embodiments of the invention are implemented.

FIG. 23 illustrates a map service operating environment, according to some embodiments.

### DETAILED DESCRIPTION

The map application of some embodiments stores its map information as a set of tiles. Each tile can contain information about roads, parks, buildings, etc. Each map presentation can be made up of multiple tiles (e.g., tiles laid out in a grid). Map applications of some embodiments use these tiles and a virtual camera to provide a three-dimensional (3D) view of the map presentations they display. In some embodiments, these 3D representations are shown as though the user was looking at the mapped area through the virtual camera. The virtual camera can be raised or lowered in some embodiments at the direct command of the user or in response to user queries (e.g., searches for locations). The camera will zoom in on parts of a larger map in response to these commands. In some embodiments, the map has multiple sets of tiles for a given area. These sets are at different scales and the tiles in the sets have different levels of detail.

The map applications of some embodiments display virtual buildings at some scales of the map (e.g., when the virtual camera is closer than some threshold distance from the map). These virtual buildings are representations of real buildings at the locations in the real world that correspond to the locations on the map presentation on which the virtual camera is focused. Because memory space on devices providing electronic maps is finite, some embodiments retrieve data, from external servers, about buildings in the areas represented by the tiles that make up the map presentation. In some embodiments the retrieved data includes data identifying the shapes and heights of those buildings. When the virtual camera of the map application of some embodiments focuses on an area that includes a tile that was not previously downloaded and saved in local storage, the application retrieves the tile from the server. In some embodiments tiles representing areas near the displayed area are downloaded from a server in anticipation that they may soon be needed as the virtual camera is panned, rotated, or zoomed to display new areas.

When the map application of some embodiments receives new data about building representations on tiles in the view of the virtual camera, rather than jarringly popping the building representations into the maps, the map application raises the buildings from the ground and fades them in as they rise.

### I. Fade In

A. Raise and Fade In after Lateral Moves

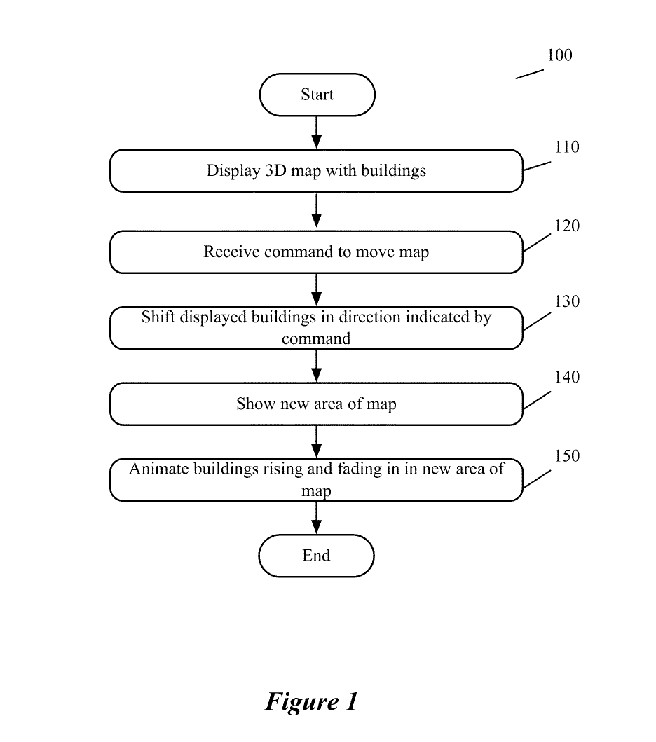

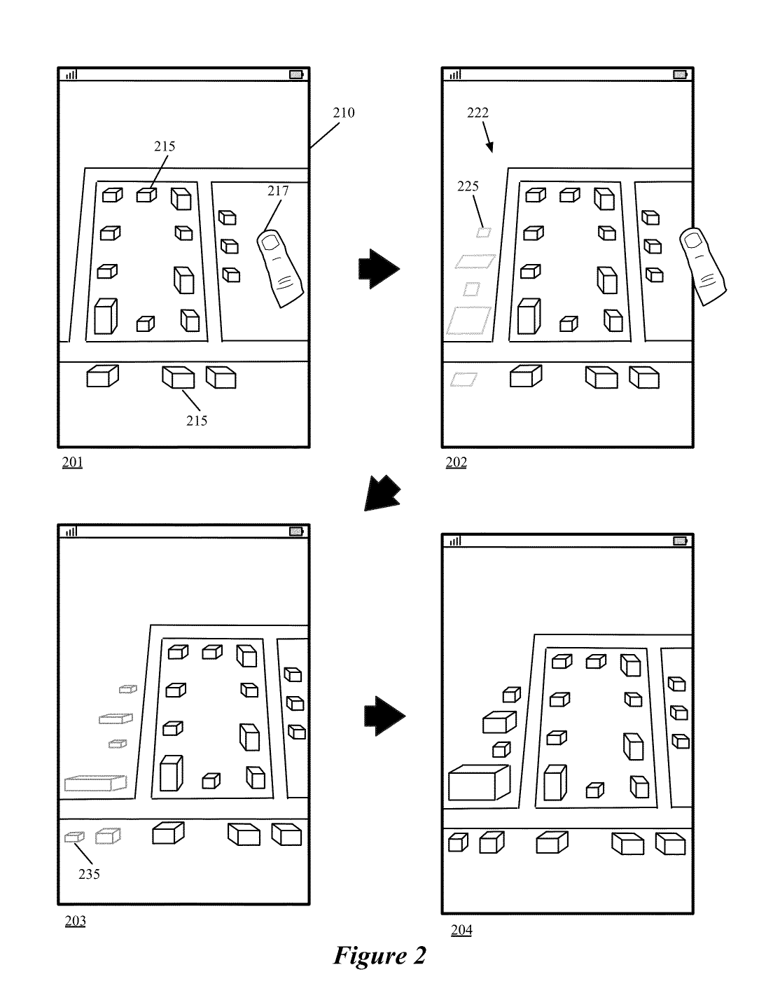

FIG. 1 conceptually illustrates a process 100 for initially displaying three-dimensional representations of buildings in a map application. The process will be described in relation to FIG. 2. FIG. 2 illustrates a map application that applies fade in and rising in a three-dimensional mode. The figure shows how fade in and rise are used in the initial display of three-dimensional representations of buildings in some embodiments. The figure shows the map application in four stages 201-204. The process 100 begins by displaying (at 110) a three-dimensional presentation of the map (sometimes referred to as a “3D presentation of the map” or a “presentation of the map in a 3D mode”) with three-dimensional representations of buildings. An example of such a map presentation 210 with three-dimensional buildings is shown in FIG. 2 in stage 201. The presentation of the map 210 is a 3D perspective presentation displayed on a touch screen of a device and includes a set of three-dimensional representations of buildings 215. In some embodiments, the 3D representations are rendered, simplified shapes. In other embodiments, the 3D figures are textured shapes generated from photographic images of the real buildings they represent. The map applications of some embodiments enable a user to switch between (1) a stylized map mode with roads rendered as sets of lines of varying thickness on the map and building representations rendered as simplified shapes and with simplified color schemes (e.g., gray building representations) and (2) a realistic mode which displays the building representations as textured shapes generated from actual photographs.

The process 100 receives (at 120) a command to move the presentation of the map. An example of this is shown in FIG. 2. The command to move the presentation of the map is a finger gesture that starts in stage 201 with a finger 217 touching a touch screen on which the presentation of the map is displayed, then dragging the presentation of the map to the right (an alternate description would be that the virtual camera has panned to the left) as is shown in stages 201 and 202. The dragging is about to stop in stage 202 and has completely stopped by stage 203. The process 100 shifts (at 130) the presentation of the map in the direction indicated by the command. This is shown in stage 202 of FIG. 2 with the presentation of the map 210 and its building representations 215 shifted to the right. As a result of shifting the presentation of the map, the process 100 shows (at 140) a new area of the presentation of the map. In FIG. 2 a new area 222 in stage 202 is shown on the left side of the presentation of the map 210. The new area 222 contains building representations 225. In stage 202, the building representations 225 are displayed as almost transparent footprints of building representations.

The process 100 then animates (at 150) the newly displayed building representations as they rise from footprints to full height three-dimensional representations of the buildings. In some embodiments, while the building representations rise from the footprints to their full heights, they also fade in. This part of the process is shown in stages 203 and 204 in FIG. 2. In stage 203, the building representations have risen partway to their full height and have faded in partway. Fading in refers to the building representations transitioning from a transparent (i.e., not displayed) or nearly transparent state (at the beginning of fading in) to an opaque (or almost opaque) state (at the end of fading in). The opacity of a pixel is sometimes referred to as the pixel's “alpha” value. The alpha value is often joined with other color values such as red, green, and blue color component values to characterize the pixel. As used herein, an opacity or alpha of 1 refers to a pixel that is completely opaque while an opacity or alpha of 0 refers to a pixel that is completely transparent (i.e., not shown visually). However, different embodiments may use different scales for opacity and/or transparency. As used herein, zero opacity is the same as full transparency.

In some embodiments, a map application begins calculating the effects of building representations rising and fading in for areas that are near, but not on the visible map presentation. That is, it performs the same mathematical calculations for raising and fading in buildings that are just out of the virtual camera's field of view as it does for raising and fading in buildings that are in the virtual camera's field of view. The map application of some embodiments does this in order to provide uniformity between the last few building representations to be dragged into the field of view and the building representations dragged into the field of view earlier. The effect of calculating raising and fade in before a building representation is visible to the user is demonstrated in stage 203. Stage 203 includes a newly displayed building representation 235. Even though the building representation was dragged into the map presentation after the other buildings 225, it is shown as being in the same stage of animation (e.g., it has reached the same portion of its height and the same opacity level as the building representations 225).

In stage 204, the process 100 has completed the animation of the building representations which have reached their full heights and are fully opaque. Once the animation is complete, the process 100 ends. However the map application continues to display the building representations at full height and opacity.

The illustrated figures show building representations beginning to be displayed near the end of a command to shift the presentation of the map. However, in some embodiments the building representations in a new area begin to appear (e.g., an almost transparent footprint of the building is displayed) earlier. In some such embodiments, a building representation begins to appear as soon as the virtual camera focuses on a portion of the area that contains the building representation (e.g., a tile containing the building). In some embodiments, representations at different stages of rise and fade in animation can be displayed at the same time. For example, in some embodiments one building could be at 50% of its full height while a more recently displayed building is at 10% of its full height, with opacity levels varying accordingly. The map application of some embodiments constantly animates new building representations as the presentation of the map is moved from one area to another. In other embodiments, building representations will appear when the presentation of the map is moving slowly, but are not displayed when the presentation of the map is moving faster than a particular threshold rate.

In contrast, some embodiments wait until the presentation of the map has stopped moving before displaying new building representations. Similarly, in other embodiments, the map applications will show newly displayed building representations only as footprints while the presentation of the map is moving. The map application then animates the building representations which rise and fade in after the presentation of the map stops moving.

Finally, in some embodiments, building representations surrounding the displayed area will be made to rise and fade in mathematically, in anticipation that the map presentation may be moved to display them. If the map application finishes raising and fading in these buildings then they will be at their full heights and opaque when the map presentation is moved to display them. In contrast, the building representations may be partially raised and partially opaque when the virtual camera is first pointed at their tiles. When the virtual camera views such tiles, the building representations will finish rising and turning opaque in the display of the map presentation in some embodiments. In other embodiments, if the building representations are not complete when the map presentation moves, the animation of the building representations will restart from zero height and full transparency.

Many figures described herein show flat building representation footprints that are almost transparent. However, in some embodiments the initial (or final for buildings being removed) opacity of the building representations is zero when they are at zero height. In such embodiments, the building representations in 3D are not visible until their height and opacity is greater than zero. One of ordinary skill in the art will understand that although the virtual objects being raised and faded in are described herein as “building representations” that in some embodiments trees, and/or other natural or artificial objects can be raised and faded in as well as, or instead of buildings.

In some embodiments, the map application raises building representations by adding successively higher layers on top of one another to raise the building from the ground (e.g., each layer is added at the level at which that layer will stay). In other embodiments, the whole building rises from a base level with the top layer added first and successive layers added at the bottom and “pushing” the previous layers higher. In still other embodiments, the buildings start out fully formed but very small and then increase in size from miniature to full sized.

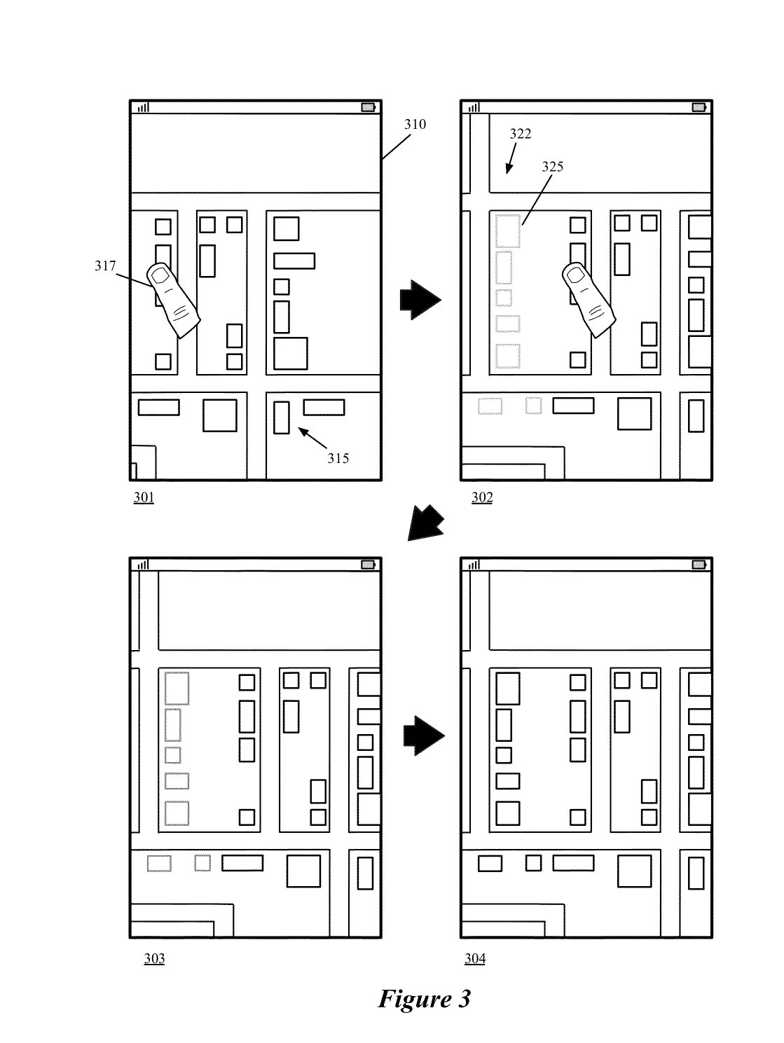

FIG. 3 illustrates a map application of some embodiments displaying building representations in a two-dimensional mode (sometimes referred to as a “2D presentation of the map” or a “presentation of the map in a 2D mode”). In the two-dimensional mode, the building representations do not rise, but still fade in. FIG. 3 includes stages 301-304. In stage 301, a presentation of the map 310 is displayed with 2D building representations 315, receiving the start of a command to move the presentation of the map to the right (by finger 317).

In stage 302, the presentation of the map 310 has moved to the right (alternately, the virtual camera has panned to the left) and a new area 322 is displayed with building representations 325. The new building representations are almost transparent in stage 302. The building representations 325 transition from transparent to opaque through stages 303 and 304. Although FIG. 3 first shows the new area 322 with almost transparent building representations displayed, in some embodiments, new areas enter the presentation of the map with the building representations not visible at all (e.g., completely transparent, simply not shown). In such embodiments, the building representations then begin to be displayed as almost entirely transparent and then transition to opacity. Similarly to the above described embodiments of the map presentations in 3D, in some embodiments building representation in areas surrounding the visible 2D map presentation area start to fade in before the area is brought into view.

B. Raise and Fade In after Zooming In

As mentioned above, the map application of some embodiments displays maps as though viewed from a virtual camera. Some map applications display building representations when the virtual camera is within a certain distance from the ground or from some arbitrary height such as sea level. One way of referring to the height of the virtual camera is to describe it in terms of zoom levels. Herein, zoom levels are used as a convenient proxy for distance. However in some embodiments, the 3D mode allows a user to move the virtual camera more freely than separate zoom levels would suggest.

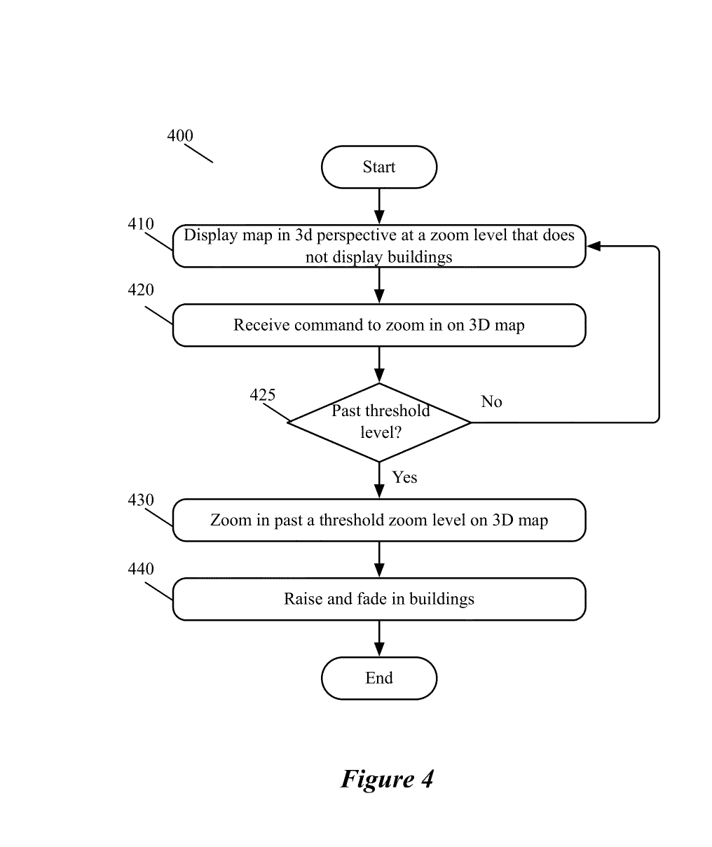

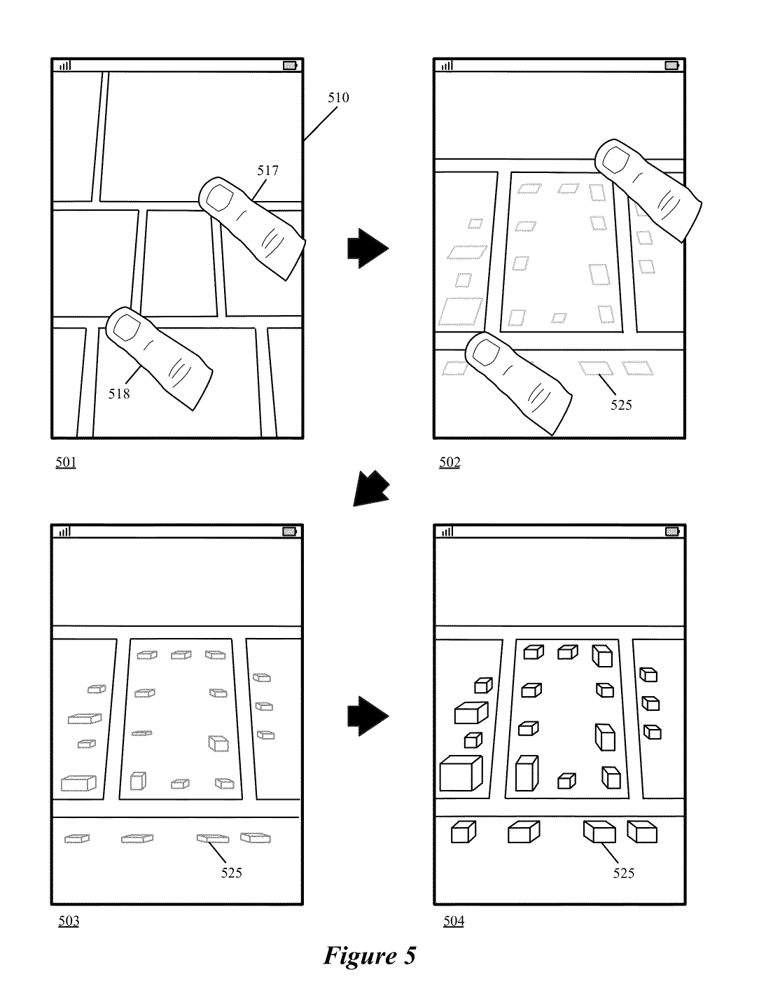

The map applications of some embodiments provide building representations at some zoom levels (heights) and not at other zoom levels. For example, in some embodiments, when the presentation of the map is zoomed out above a threshold height level, the building representations are not shown. When the presentation of the map is zoomed in to the threshold level or zoomed in below the threshold level, the building representations are shown. FIG. 4 conceptually illustrates a process of some embodiments for raising and fading in building representations after zooming in on a presentation of the map. FIG. 5 illustrates rising and fading in building representations after zooming in to the threshold level on the presentation of the map in 3D mode. FIG. 4 will be described in relation to FIG. 5. FIG. 5 is illustrated in stages 501-504. The process 400 begins by displaying (at 410) a presentation of the map in a 3D perspective. An example of this is shown in stage 501 of FIG. 5. This stage 501 shows a presentation of the map 510 in a three-dimensional perspective, but with no building representations shown. The presentation of the map shows roads 515, but no building representations because at this particular scale (zoom level) of the presentation of the map, the building representations are not displayed (e.g., because they would be too small or too numerous to be useful).

The process 400 then receives (at 420) a command to zoom in on the presentation of the map. This is illustrated by the two fingers 517 and 518 moving apart between stages 501 and 502 of FIG. 5. The process then determines (at 425) whether the command to zoom in will take the virtual camera to or past the threshold level. If it does not, then the process 400 returns to operation 410 and the map presentation continues to be displayed without buildings. If the process determines (at 425) that the command will cause the virtual camera to be zoomed in to or past the threshold level, then the process 400 zooms in (at 430) to or past the threshold level for displaying building representations. This is illustrated in FIG. 5 by stage 502, in which the roads 515 have moved farther apart and gotten wider in response to the change of the scale (zoom level) of the presentation of the map. In this stage 502, the footprints of building representations 525 have appeared in an almost transparent state.

The process 400 then raises and fades in (at 440) the building representations. This is illustrated in stages 503 and 504. In stage 503, the building representations are half of their full heights and more opaque than in stage 502. In stage 504, the building representations have reached their full heights and are fully opaque. The process 400 ends when the building representations have reached their full heights and are fully opaque.

The map application of some embodiments includes both flat 2D (overhead) presentations of the maps and 3D perspective presentation of the maps. In some embodiments, the map application allows a user to zoom in (past the threshold zoom level for displaying building representations) while in 2D mode. The map applications of some embodiments fade in the building representations in a 2D presentation of the map. Afterward, if the user commands that the map presentation transitions to a 3D mode, the map raises the building representations after the transition to the 3D mode.

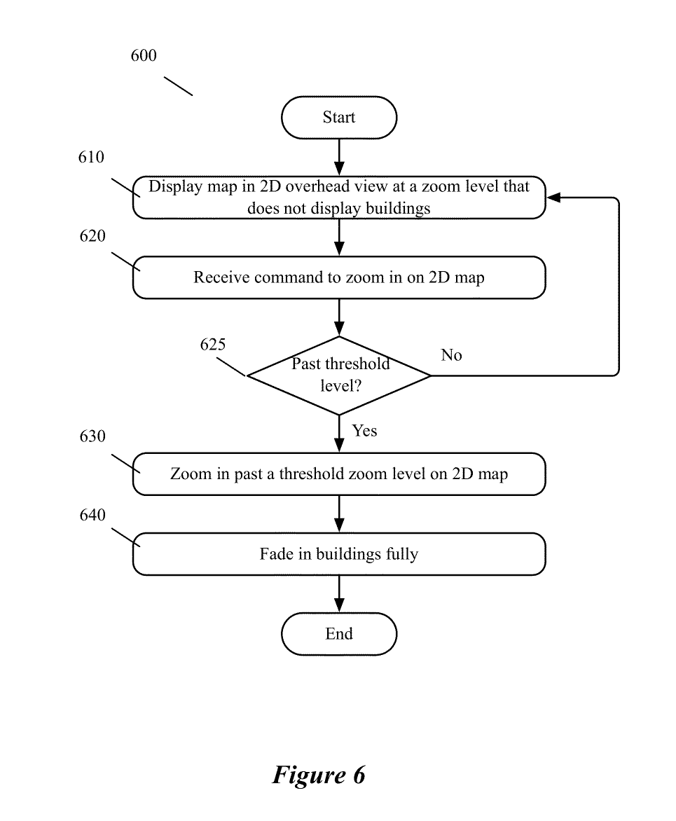

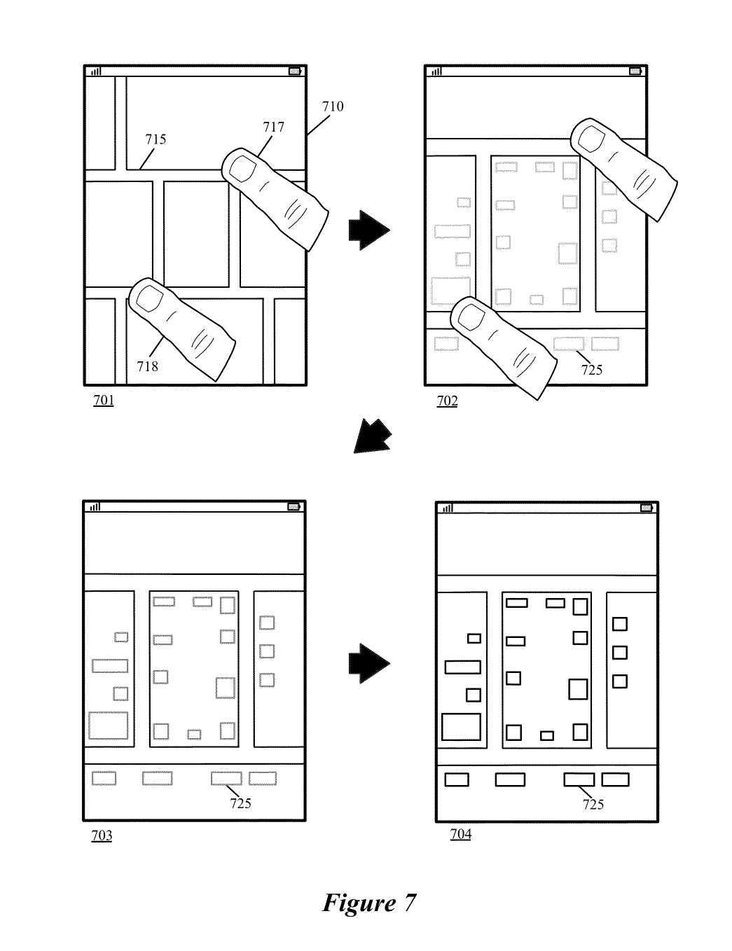

FIG. 6 conceptually illustrates a process of some embodiments for fading in building representations in a 2D presentation of the map. FIG. 7 illustrates zooming in to the threshold level on 2D map presentation mode. FIG. 6 will be described in relation to FIG. 7. FIG. 7 is illustrated in stages 701-704. The process 600 begins by displaying (at 610) a presentation of the map in a 2D perspective. An example of this is shown in stage 701 of FIG. 7. This stage 701 shows a presentation of the map 710 in a two-dimensional perspective, with roads 715 but with no building representations shown. At this particular scale of the presentation of the map, the map application of the illustrated embodiment does not display building representations.

The process 600 then receives (at 620) a command to zoom in on the presentation of the map. This is illustrated by the two fingers 717 and 718 moving apart between stages 701 and 702 of FIG. 7. The process then determines (at 625) whether the command to zoom in will take the virtual camera to or past the threshold level. If the command does not take the virtual camera to or past the threshold level, then the process 600 returns to operation 610 and the map presentation continues to be displayed without building representations. If the process determines (at 625) that the command will cause the virtual camera to be zoomed in to or past the threshold level, then the process 600 zooms in (at 630) to or past the threshold level for displaying building representations. This is illustrated in FIG. 7 by stage 702, in which the roads 715 have moved farther apart and gotten wider in response to the change of the scale of the presentation of the map. In this stage 702, the footprints of building representations 725 have appeared in an almost transparent state.

The process 600 then fades in (at 640) the building representations. This is illustrated in stages 703 and 704. In stage 703, the building representations 725 are more opaque than in stage 702. In stage 704, the building representations 725 are fully opaque. The process 600 ends when the building representations are fully opaque.

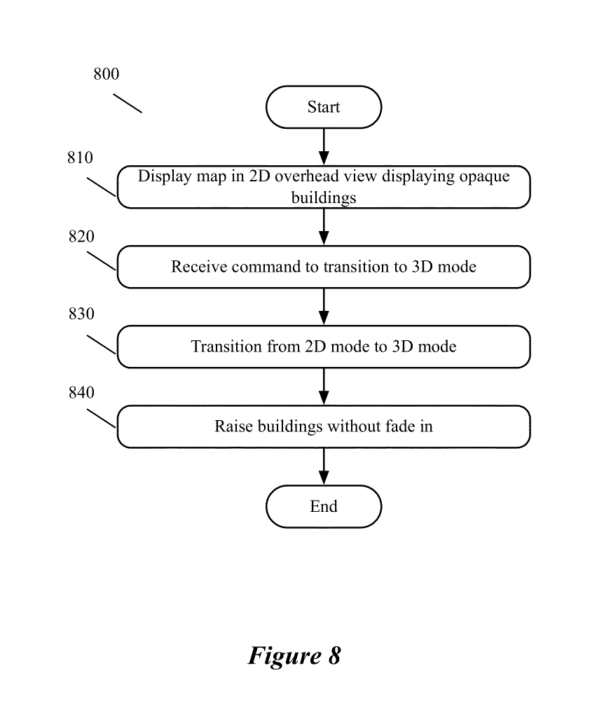

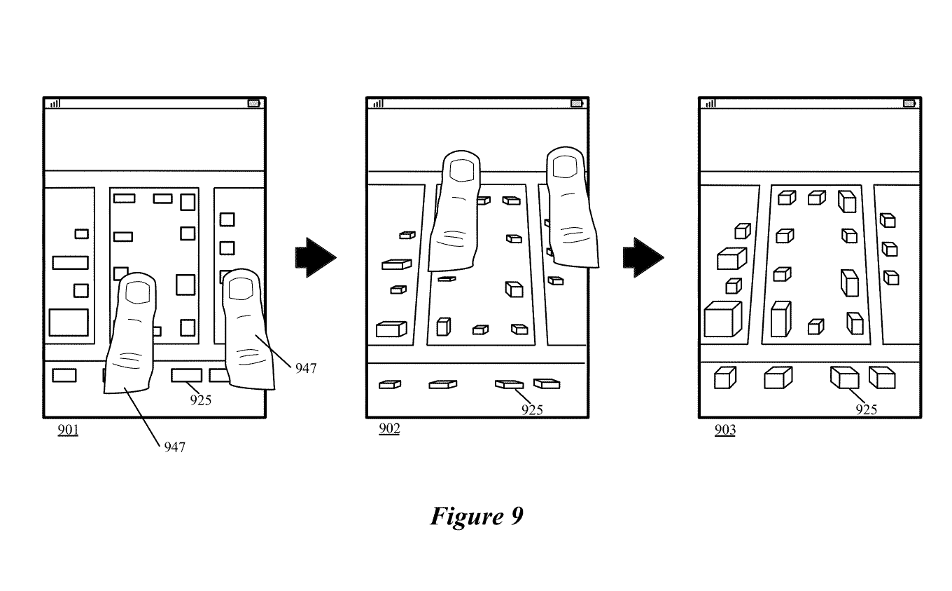

In some embodiments, when the map presentation is in a 2D mode and the building representations are fully faded in (opaque), the user can command the map application to switch the map into a 3D mode. This does not always immediately follow zooming in in 2D mode in some embodiments, the user decides whether to transition to 3D mode. FIG. 8 conceptually illustrates a process of some embodiments for raising opaque building representations after a transition to a 3D mode. The figure will be described with respect to FIG. 9. FIG. 9 illustrates a map transitioning a map presentation in a 2D mode, with opaque building representations, to a 3D mode. FIG. 9 is shown in stages 901-903.

The process 800 displays (at 810) a 2D map presentation with opaque building representations. Opaque building representations 925 are shown in stage 901 in FIG. 9. The process then receives (at 820) a command to transition to a 3D mode. This is shown in FIG. 9 by the two fingers 947 dragging upward from stage 901 to stage 902. In the illustrated embodiment, dragging two fingers upward commands the map to “tilt” away from the user, taking the map presentation from a 2D mode to a 3D mode, or if the map presentation is already in a 3D mode, pushing upward with two fingers moves the map to show the land from a steeper angle (up to some angular limit in some embodiments).

The process 800 then transitions (at 830) the map presentation from 2D mode to 3D mode. In some embodiments, after the building representations 925 have been faded in in 2D mode, they remain opaque as they rise after the transition to a 3D mode. Accordingly, the process 800 raises (at 840) the building representations 925 without fade in. This is shown in FIG. 9 stage 902, in which the building representations 925 are at half their total height, but already entirely opaque. The process 800 ends when the building representations are fully risen. Full height building representations 925 are shown in stage 903 of FIG. 9.

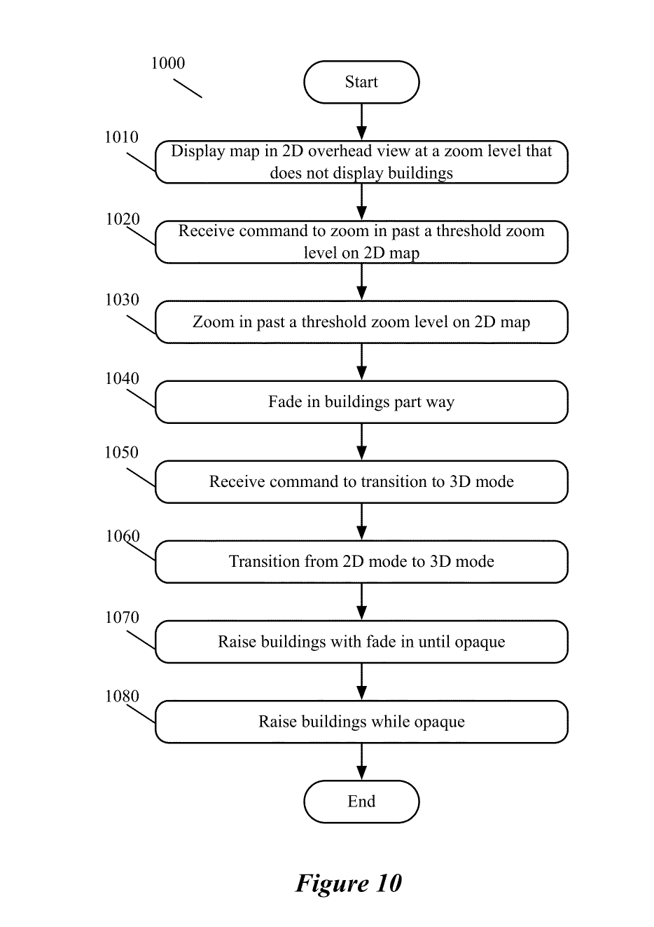

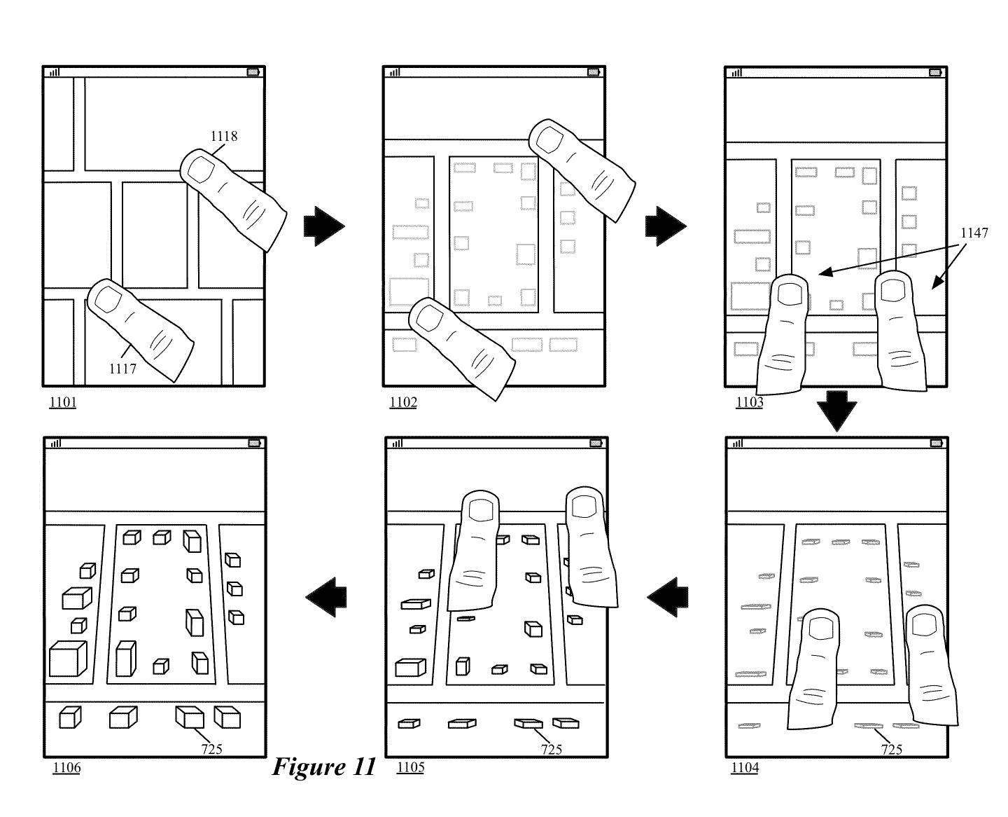

In the process 800 of FIG. 8 and stages of FIG. 9 the user has waited until the building representation footprints in the 2D mode are opaque before commanding the application to transition to a 3D mode. However, the applications of some embodiments also allow the user to command a transition into 3D mode before the building footprints are fully opaque. FIGS. 10 and 11 combine a zoom in process that is interrupted before the building representations have fully faded in with a transition to 3D that occurs during the fading in of the buildings in 2D.

FIG. 10 conceptually illustrates a process of some embodiments for fading in building representations in a 2D presentation of the map and raising them after an early transition to a 3D mode. FIG. 11 illustrates zooming in to the threshold level in a 2D map mode, then transitioning to a 3D map mode while building representations are fading in. FIG. 10 will be described in relation to FIG. 11. FIG. 11 is illustrated in stages 1101-1106. The process 1000 begins by displaying (at 1010) a presentation of the map in a 2D perspective. An example of this is shown in stage 1101 of FIG. 11. This stage 1101 shows a presentation of the map 1110 in a two-dimensional perspective, with roads 1115 but with no building representations shown. At this particular scale of the presentation of the map, the map application does not display building representations.

The process 1000 then receives (at 1020) a command to zoom in on the presentation of the map. This is illustrated by the two fingers 1117 and 1118 moving apart between stages 1101 and 1102 of FIG. 11. The process 1000 then zooms in (at 1030) to the threshold level for displaying building representations. This is illustrated in FIG. 11 by stage 1102, in which the roads 1115 have moved farther apart and gotten wider in response to the change of the scale of the presentation of the map. In this stage 1102, the footprints of building representations 1125 have appeared in an almost transparent state.

The process 1000 then partly fades in (at 1040) the building representations. This is illustrated in stage 1103. In stage 1103, the building representations 1125 are more opaque than in stage 1102. The process then receives (at 1050) a command to transition to a 3D mode. This is shown in FIG. 11 by the two fingers 1147 dragging upward from stage 1103 to stage 1104. The process 1000 then transitions (at 1060) the map presentation from 2D mode to 3D mode. In some embodiments, after the building representations have been partly faded in in 2D mode (to some level of opacity), they retain that level of opacity at the moment of transition to the 3D mode, then increase their opacity as they rise after the transition to a 3D mode. Accordingly, the process 1000 raises (at 1070) the building representations while also fading them in. This is shown in stage 1104 of FIG. 11, in which the building representations are at one quarter of their total height, but slightly more opaque than the building footprints in stage 1103. The operation 1070 ends when the building representations are fully opaque. This is shown in stage 1105 of FIG. 11, in which the building representations are half risen, but completely opaque.

The process 1000 then raises (at 1080) the building representations to their full height while they are fully opaque. The end result, shown in stage 1106 is a presentation of the map in a 3D presentation of the map with fully risen, fully opaque building representations 1125. The process 1000 then ends.

The embodiments of the map application illustrated in FIGS. 6-11 include building representations that rise when the map application transitions from a 2D presentation of the map mode to a 3D presentation of the map mode. However, in some embodiments, during the fade in, the map applications calculate the rising of the building representations in a 2D mode as though the application was in the 3D mode, without displaying the rising of the building representations until the application is transitioned to the 3D mode. That is, in such embodiments, when the application transitions from 2D to 3D mode, the building representation will be displayed at a height as though they were in 3D mode all along. For example, if an application (1) takes 1 second to raise a building representation to half its full height in 3D mode, (2) zooms into the threshold zoom level in 2D mode, and (3) is in that mode at that zoom level for 1 second before transitioning to 3D mode, then when the application transitions to 3D mode, the representation in that embodiment will be initially presented at half its total height (and rising) with opacity corresponding to that fraction of its height just as if the map presentation had been in 3D mode all along.

In still other embodiments, the building representations start back at transparent and flat when the application transitions from 2D mode to 3D mode. In such embodiments, the building representations then rise from the ground and fade in, in a manner similar to their rising and fading in when zooming in to the threshold level in 3D mode.

In the illustrated embodiments, the building representations rise at a speed proportional to their final height. Thus if two building representations enter the presentation of the map at the same time, they will each be at the same fraction of their respective final heights at the same time. When one building representation is half its final height, the other representation will be half its final height as well. However, in some embodiments, the building representations grow at a constant rate so that all building representations that enter together and are still growing will be at the same height until one of them stops growing. In some such embodiments, a building representation that is twice the height of another building representation will take longer (e.g., twice as long) to reach its full height. One of ordinary skill in the art will understand that building representations growing at a constant rate are within the scope of some embodiments, as are building representations that grow at any non-constant rate including proportionately to their final heights and non-proportionately to their final heights.

In the previously described embodiments, the map application raises and fades in building representations when it is instructed to display a new area. In some embodiments, the application runs the same calculations for raising and fading in building representations in an area surrounding the displayed area. In some such embodiments, moving the virtual camera to a new area that has been pre-calculated will show the buildings in that area come into view already at their full height and opacity. Furthermore, some embodiments skip the rising and fading in for areas near the visible area of the map and simply calculate those buildings as being at full height and opacity as soon as the data about them is downloaded. The user in either of those embodiments would simply see the buildings slide into view when the map presentation moves to display the pre-calculated area.

In contrast, moving the virtual camera to a new area that has not been pre-calculated will cause the map application to actually show building representations as they rise and fade in. Similarly, in some embodiments, moving to a previously undisplayed area for which the application is in the process of such pre-calculation will initially display building representations partly raised and faded in, which then continue being raised and fading in.

The above described figures illustrate map applications adding building representations to the map presentations when moving laterally or zooming in. However, in other embodiments the map application may add building representations under other circumstances. For example, some map applications have multiple modes such as a stylized or representational map presentation mode and a mode that displays actual photographs, or data derived from actual photographs of the areas of the map presentation. Such a photographic mode is sometimes called a “satellite mode” or a “flyover mode”. The map applications of some embodiments raise and fade in building representations upon switching from the photographic mode to the stylized mode. In embodiments that show buildings rising and fading in in satellite mode, the map application may cause building representations to rise when switching into the satellite mode as well.

Map applications of some embodiments raise and lower a view of a virtual camera while entering or leaving a 3D mode. In some embodiments, the map application can tilt into 3D and lower the virtual camera past the threshold distance for adding building representations. In some embodiments going from one 3D view to another 3D view seen from a lower perspective can also put the map presentation closer than the threshold distance and thus cause the map presentation to raise and fade in building representations. In some embodiments, rotating the map presentation may bring into view new areas in which the building representations have not been calculated. Similarly, when another application opens maps with a target location or when a server or a local database returns a search result (and moves the map to a location found in the search) this may bring the map to an area that has not previously had building representations calculated. In any of the above described circumstances, the map application will raise and fade in the building representations in some embodiments.

The map application of some embodiments animates rising and fade in based not on whether a tile is newly displayed (and also not pre-calculated), but on whether the area that the tile represents is newly displayed (and also not pre-calculated). In a tile based map system, a single area (e.g., an area bounded by four roads) may be included in the data of multiple tiles at different scales (different zoom levels). The map application of some embodiments begins the display of a building representation in a particular area while displaying a set of tiles at one scale, and maintains the display of that building representation while displaying a new set of tiles at a different scale. Thus, while zooming in to the closest level of the map from the threshold level may display multiple sets of tiles (i.e., one set at each of multiple zoom levels), a building representation in the area that the map application is being zoomed in on will simply grow along with the zoom level, without being animated as rising and fading in as a building representation in a newly viewed (and not pre-calculated) area would be. Similarly, zooming out will display new tiles, but does not necessarily display an area that is newly displayed and not pre-calculated. Accordingly, a newly displayed tile is not necessarily a new area, so a newly displayed tile will not necessarily include buildings to be animated in some embodiments.

In some embodiments, the application locally stores data about previously viewed tiles. In some such embodiments, an area counts as a new area for purposes of raising building representations only if the application does not have the building representation data for the area locally stored. Different embodiments store data about building representations for different amounts of time or store different numbers of bytes of data. In some embodiments, panning to a distant area and back within a few minutes will clear the building representation data for that area. In other embodiments, more data is stored or data is stored for longer so panning back to a recently viewed area will show buildings already at full height and opacity. It will be clear to one of ordinary skill in the art that a “newly displayed area” is not necessarily an area that has never had building representations displayed, but one in which the application does not currently have building representation data displayed when the area is moved into view or zoomed into.

### II. Fade Out

A. Lower and Fade Out in the Distance

Just as it would be confusing to have the building representations appear instantly without fading in and rising, it would also be jarring in some circumstances to have the building representations disappear instantly without fading out and lowering. Accordingly, map applications of some embodiments reverse the process of raising and fading in the building representations when the building representations reach certain locations on the presentation of the map (outside of a displayed range) or when the presentation of the map is zoomed out past the threshold level at which building representations are permanently displayed. In some embodiments, lowering a building representation involves sequentially removing layers of the building representation from a top down. In other embodiments, lowering a building representation involves removing layers from the bottom up and having the higher levels drop lower, as though the building was sinking In still other embodiments, lowering a building representation involves shrinking the building.

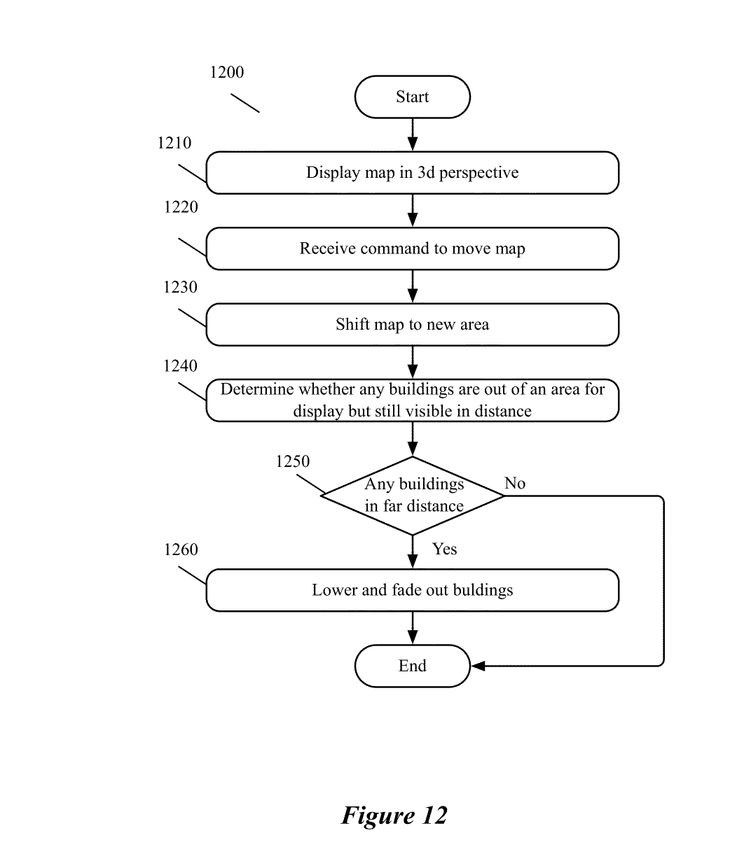

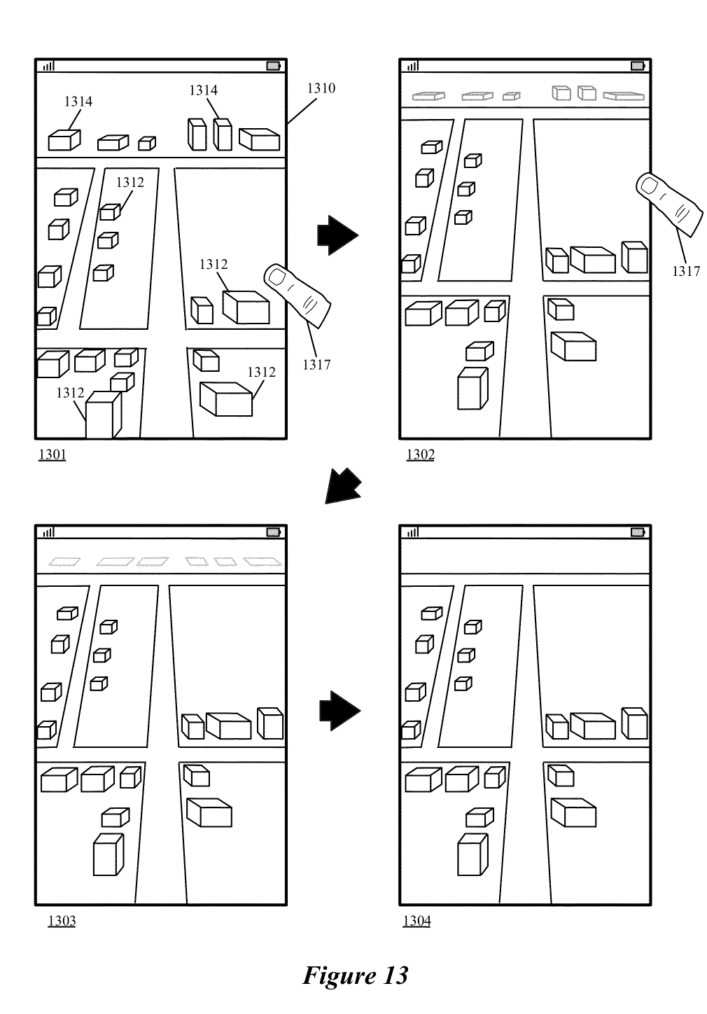

FIG. 12 conceptually illustrates a process 1200 of some embodiments for removing building representations from part of a 3D presentation of the map. The process 1200 will be described by reference to FIG. 13. FIG. 13 illustrates a map application removing building representations in a 3D presentation of the map. FIG. 13 shows the removal of buildings in stages 1301-1304. The process 1200 begins by displaying (at 1210) a 3D presentation of the map. An example of a presentation of the map 1310 in 3D mode is shown in stage 1301 of FIG. 13. The presentation of the map 1310 includes building representations 1312 and 1314. Building representations 1312 are close to the center of the presentation of the mapped area. Building representations 1314 are farthest from the center of the presentation of the mapped area and furthest from the virtual camera.

The process 1200 receives (at 1220) a command the move the presentation of the map. An example of receiving a command to move the presentation of the map 1310 is illustrated in stages 1301 and 1302 of FIG. 13. The command to move the presentation of the map is shown as finger 1317 drags the presentation of the map up between stages 1301 and 1302. The process 1200 shifts (at 1230) the presentation of the map in response to the received command. This is shown by the presentation of the map 1310 in stage 1302 being shifted upward in relation to the presentation of the map 1310 in stage 1301. The process 1200 then determines (at 1240) whether any building representations are outside the desired building display area, but still visible on the presentation of the map 1310. In FIG. 13 in stage 1302, the building representations 1314 are outside the desired building display area, but still visible on the presentation of the map. If the process determines (at 1250) that there are no building representations outside the desired display are, then the process ends. If the process determines (at 1250) that there are any building representations outside the display area (e.g., on tiles in the far distance), then the process 1200 lowers and fades out (at 1260) those building representations. Lowering and fading out of building representations 1314 is shown in stages 1302-1304. In stage 1302, the building representations 1314 have lowered to half their original heights, and faded from opaque to partly transparent. In stage 1303, the building representations 1314 have lowered until only the footprints of the building representations remain and those footprints are almost entirely transparent. In stage 1304, the building representations 1314 are no longer displayed. Once the distant building representations are no longer displayed, the process 1200 ends.

Although process 1200 of FIG. 12 and process 100 of FIG. 1 are described separately, in the map application of some embodiments these processes go on simultaneously. In such applications, one set of building representations can be lowering and fading out in the distance at the same time as another set of building representations are rising and fading in, in the foreground. Furthermore, in some embodiments, building representations that are moved entirely off the presentation of the map and therefore not visibly displayed are treated by the application as lowering and fading out, such lowering and fading out can be seen in some embodiments if the area containing the building representations is returned to the visible part of the presentation of the map before they have completely lowered and faded out in some embodiments.

B. Lower and Fade Out while Zooming Out

As described previously in section A, the map application of some embodiments displays building representations fading in and/or rising when the presentation of the map is zoomed to or past a threshold level. Similarly, the map applications of some embodiments cause building representations to fade out and/or fall when zooming out past the threshold zoom level. That is, even though a presentation of the map level does not display building representations in a sustained manner, building representations will be shown at that zoom level long enough for the user to see them lower (in 3D mode) and fade out (in both 2D mode and 3D mode) before they are no longer displayed.

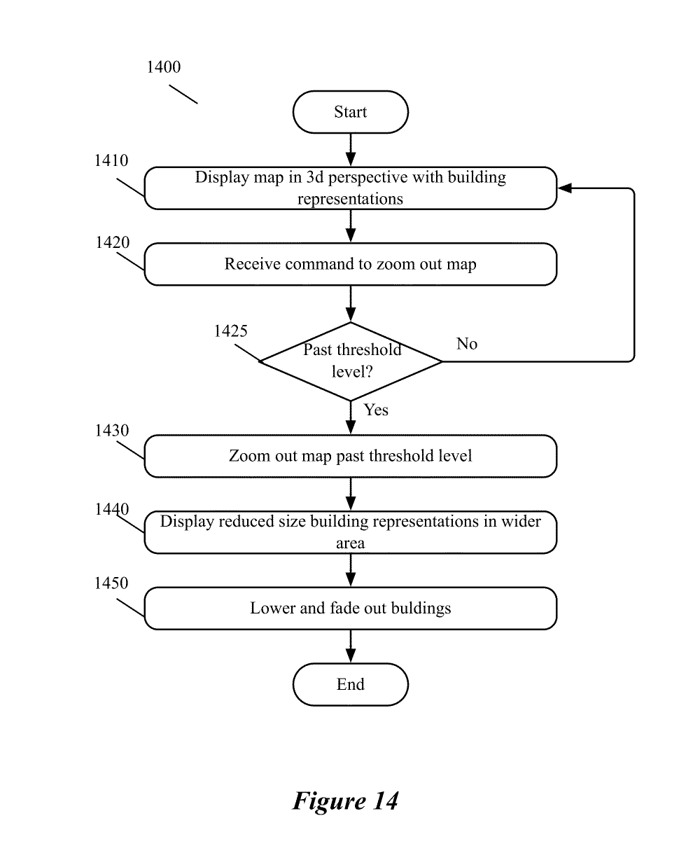

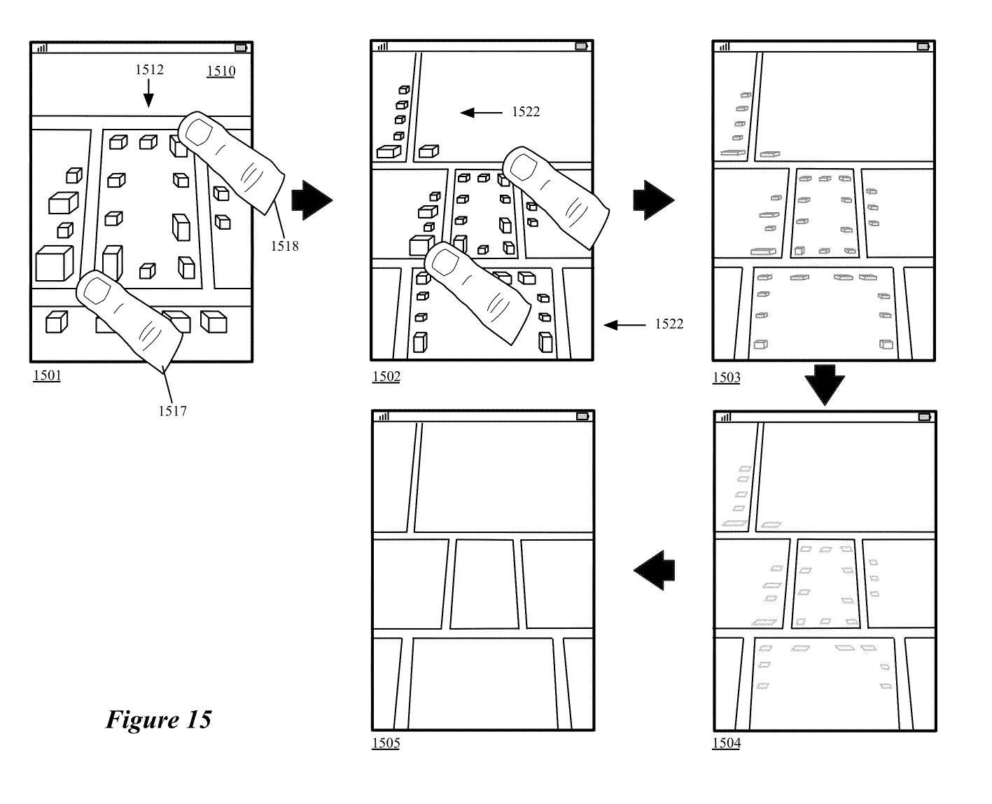

FIG. 14 conceptually illustrates a process 1400 of some embodiments for zooming out a 3D presentation of the map of a map application. FIG. 14 will be described in relation to FIG. 15. FIG. 15 illustrates a map application zooming out a 3D presentation of a map past (above) a threshold zoom level for displaying building representations. FIG. 15 is illustrated in stages 1501-1505. The process 1400 begins by displaying (at 1410) a presentation of the map in a 3D perspective mode with building representations shown. An example of a presentation of a map in a 3D perspective mode is illustrated in stage 1501 of FIG. 15. In this stage 1501, the presentation of the map 1510 (or the virtual camera) is at or below the threshold zoom level for displaying building representations 1512. The process 1400 then receives (at 1420) a command to zoom out the presentation of the map. This is shown in FIG. 15 stages 1501 and 1502, which show fingers 1517 and 1518 placed on the display and brought toward each other in order to command the application to zoom out the presentation of the map 1510.

The process 1400 determines (at 1425) whether the zoom command will take the map past (above) the threshold level. If not, then the process 1400 returns to operation 1410 and continues to display the map with the building representations, though zoomed out farther than before. If the process determines (at 1425) that the zoom command will take the map presentation past (above) the threshold level then the process zooms out (at 1430) the presentation of the map past the threshold. An example of this is shown in stage 1502 of FIG. 15. The presentation of the map 1510 has been changed to a larger scale, representing a larger area of land. The process 1400 also displays (at 1440), at a reduced size, the building representations from both the originally displayed area and the area surrounding the originally displayed area. The presentation of the map 1510 in stage 1502 shows this, as shrunken building representations 1512 are shown in the (shrunken) original area of the presentation of the map 1510 and building representations 1522 are shown in area surrounding the originally displayed area.

In some embodiments, the surrounding building representations 1522 are identified, their heights calculated, and the representations displayed at full height and opacity while the map application is zooming out. In other embodiments, the heights and other features of the representations of buildings surrounding a displayed area are pre-calculated in case the user makes a command that brings those areas into view. In such embodiments, the pre-calculated building representations are displayed when the presentation of the map zooms out.

As the presentation of the map is now at a zoom level above the threshold level for permanently displaying building representations, the process 1400 lowers and fades out (at 1450) the building representations from both the previously displayed area and the wider area. This is illustrated in stages 1503-1505 in FIG. 15. In stage 1503, the building representations 1512 and 1522 are partly transparent and have been lowered to half their original height. In stage 1504, the building representations 1512 and 1522 have been reduced to almost transparent footprints. In stage 1505 even the footprints of building representations 1512 and 1522 are no longer displayed.

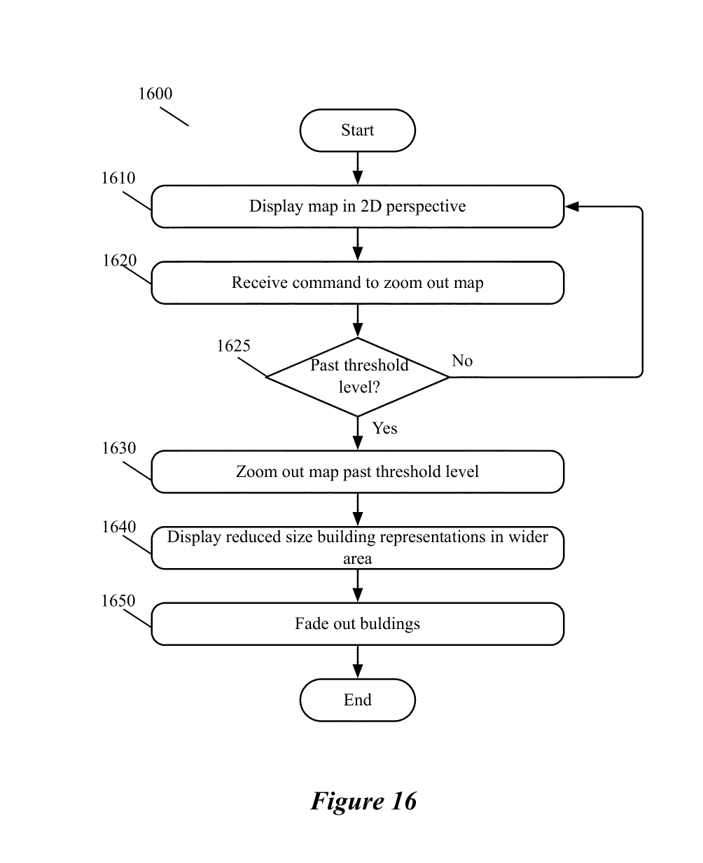

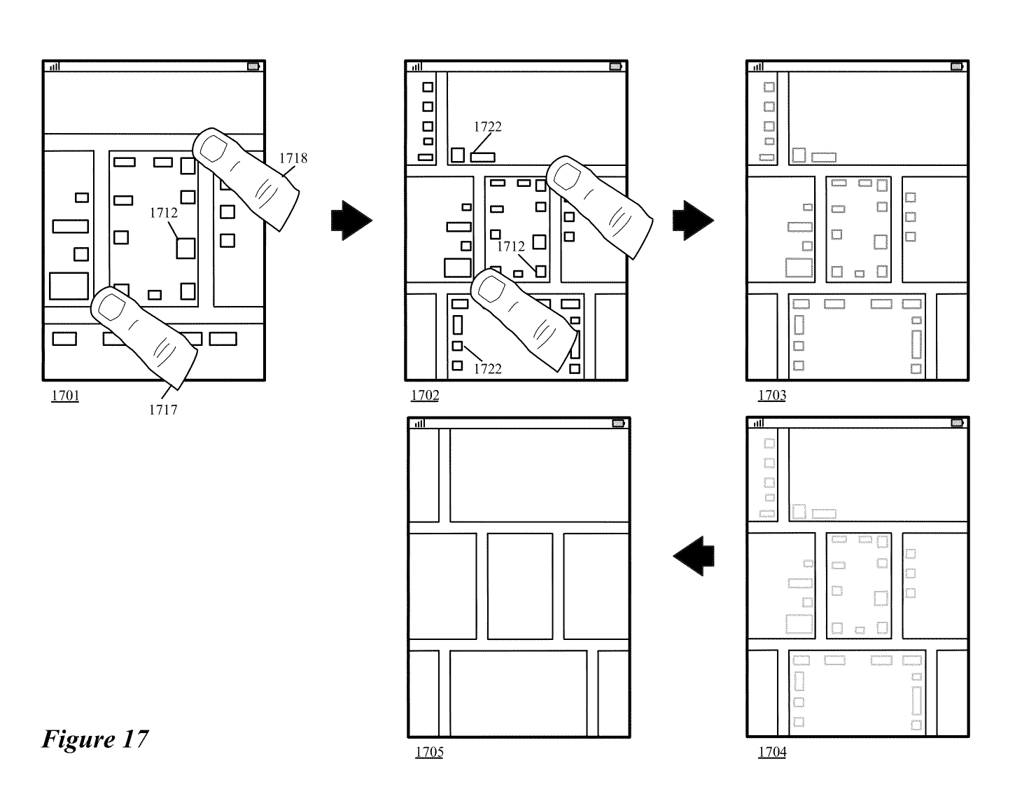

When the application of some embodiments zooms out in a 2D presentation of the map, the building representations fade out, but are already flat so they do not lower. FIG. 16 conceptually illustrates a process 1600 of some embodiments for zooming out a 2D presentation of the map of a map application. FIG. 16 will be described in relation to FIG. 17. FIG. 17 illustrates a 2D map presentation being zoomed out past (above) a threshold level for displaying building representations. FIG. 17 is illustrated in stages 1701-1705. The process 1600 begins by displaying (at 1610) a presentation of the map in a 2D perspective mode. An example of a presentation of the map 1710 in a 2D perspective mode is illustrated in stage 1701 of FIG. 17. In this stage, the presentation of the map 1710 is at or below the threshold zoom level for displaying building representations 1712. The process 1600 then receives (at 1620) a command to zoom the presentation of the map out. This is shown in FIG. 17 stages 1701 and 1702, which show fingers 1717 and 1718 placed on the display and brought toward each other in order to command the application to zoom out the presentation of the map 1710.

The process 1600 determines (at 1625) whether the zoom command will take the map past (above) the threshold level. If not, then the process 1600 returns to operation 1610 and continues to display the map with the building representations, though zoomed out farther than before. If the process determines (at 1625) that the zoom command will take the map presentation past (above) the threshold level then the process zooms out (at 1630) the presentation of the map past (above) the threshold level for displaying building representations. An example of this is shown in FIG. 17 stage 1702. The presentation of the map 1710 has been changed to a larger scale, representing a larger area of land. The process 1600 also displays (at 1640), at a reduced size, the building representations from both the originally displayed area and the area surrounding the originally displayed area. The presentation of the map 1710 in stage 1702 shows this, as shrunken building representations 1712 are shown in the (shrunken) original area of the presentation of the map 1710 and building representations 1722 are shown in the area surrounding the originally displayed area.

In some embodiments, the surrounding building representations 1722 are identified and the representations displayed at full opacity while the map application is zooming out. In other embodiments, the opacity and footprints of the representations of buildings surrounding a displayed area are pre-calculated in case the user makes a command that brings those areas into view. In such embodiments, the pre-calculated building representations are displayed when the presentation of the map zooms out.

As the presentation of the map is now above the threshold level (e.g., the virtual camera is far from the virtual ground) for displaying building representations, the process 1600 fades out (at 1650) the building representations from both the previously displayed area and the wider area. This is illustrated in stages 1703-1705 in FIG. 17. In stage 1703, the building representations 1712 and 1722 are partly transparent. In stage 1704, the building representations 1712 and 1722 have been reduced to almost entirely transparent representations. In stage 1705 the building representations 1712 and 1722 are no longer displayed.

Similarly to FIGS. 1-11 on adding building representations, FIGS. 12-17 illustrate map applications removing building representation from the map presentations when moving laterally or zooming out. However, in other embodiments the map application may remove building representations under other circumstances. For example, map applications of some embodiments raise and lower a view of a virtual camera while entering or leaving a 3D mode. In some embodiments, the map application can tilt out of 3D and raise the virtual camera past the threshold distance for removing building representations. Furthermore, in some embodiments going from one 3D view to another 3D view seen from a higher perspective can also put the map presentation farther from the virtual camera than the threshold distance and thus cause the map application of that embodiment to lower and fade out building representations. Similarly, rotation of the map presentation can put building representations into areas that are out of the area in which building representations should be rendered. In which case, the map application of some embodiments will lower and fade out the building representations.

The above described figures show building representations lowering and fading at the same time. However, the map application of some embodiments causes buildings to lower but not to fade when switching from 3D mode to 2D mode (assuming the 2D mode is still below the threshold for displaying building representations).

### III. Detailed Processes for Raising and Lowering Building Representations

A. Raising and Fade In of Building Representations

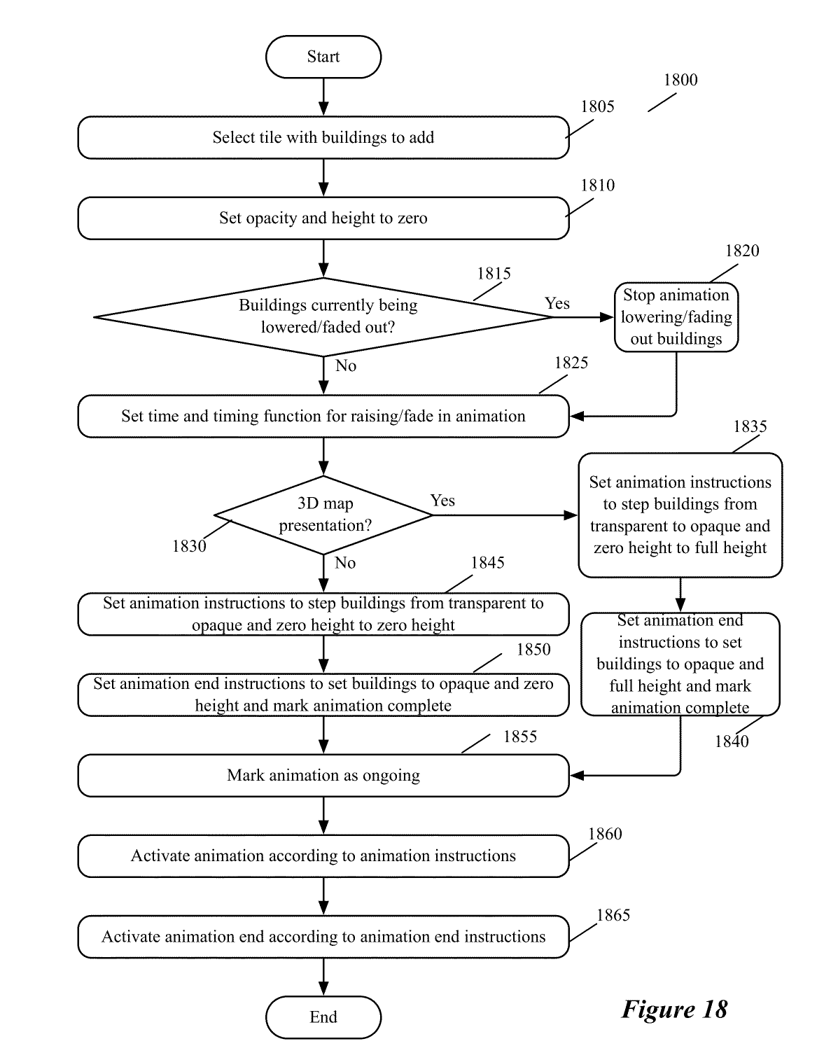

The rise and fade in process of some embodiments provides directions for animating the rise and fade in of the building representations. FIG. 18 illustrates a process 1800 of some embodiments for directing and animating building representations being added to a map presentation. The process selects (at 1805) a tile that contains building representations to be added. As previously described with respect to FIGS. 1-11, this tile can be a tile in areas that the map presentation is shifted to, or tiles on a map presentation that is zoomed past (below) a threshold level. The tile could also be a tile that has a new requirement for building representations for some other reason (e.g., rotation of the map presentation, tilting down from 2D to 3D mode, lowering the camera in 3D mode, or switching map presentation modes).

After identifying the tile, the process 1800 sets (at 1810) the opacities and heights of the building representations in that tile to zero. This allows the tile animation to start displaying the building from the ground level and from a completely transparent state (i.e., not displayed).

As previously described with respect to FIGS. 12-17, the map applications of some embodiments lower and fade out building representations in some circumstances. It is possible that a tile in the middle of an animation process to remove a building can re-enter the area in which building representations are drawn (e.g., by a user zooming in a map presentation that is removing building representations before the building representations are fully removed). Accordingly, the process 1800 of some embodiments determines (at 1815) whether the tile is currently in the middle of an animation to lower and/or fade out the building representations. If the application determines (at 1815) that the tile is in the middle of such an animation, the process 1800 stops (at 1820) the animation and goes to operation (1825). If the process determines (at 1815) that the tile is not being animated to lower building representations, then it goes directly to operation 1825.

The process 1800 then sets (at 1825) a duration and a timing function for raising and fading in the building representations. The duration determines how long the eventual animation of the building representations rising and fading in should take, and the timing function determines how much of the building will be done at what times within the animation time. The simplest timing function, used by some embodiments, is a linear timing function from start to finish. When using such a linear timing function, the portion of the building that is completed is the same as the portion of the time completed. For example, if the duration is set to 0.8 seconds, then the linear timing function will have the building one quarter raised and one quarter opaque at 0.2 seconds, half raised and half opaque at 0.4 seconds, etc. In other embodiments, the map application uses a timing function that sets the animation to ease into the rising and fading in and then go faster toward the end of the rise and fade in animation.

The process then determines (at 1830) whether the map presentation is currently in a 3D mode or a 2D mode. If the map presentation is in a 3D mode, the process 1800 sets (at 1835) animation instructions to step the building representations from transparent to opaque and from zero height to their full height. The animation instructions are set by operation 1835. However, the process 1800 does not perform the actual animation yet. The process sets (at 1840) instructions for the end of the animation. The instructions for ending the animation include instructions to set the building representations to their full heights and full opacity. In some embodiments the end animation instructions include an instruction to set a variable indicating that the animation of the tile is complete (i.e., to mark the animation for the tile as being complete). The process then proceeds to operation 1855.

When the process determines (at 1830) that the map presentation is in a 2D mode, the operation sets (at 1845) animation instructions to step the building representations from transparent to opaque. The instructions set the animation to step the building representations from zero height to zero height (i.e., to maintain a 2D character for the building representations). The animation instructions are set by operation 1845. However, the process 1800 does not perform the actual animation yet. The process sets (at 1850) instructions for the end of the animation. The instructions for ending the animation include instructions to set the building representations to zero height and full opacity and in some embodiments an instruction to set a variable indicating that the animation of the tile is complete. The process then proceeds to operation 1855.

The process 1800 marks (at 1855) the animation as ongoing (e.g., by setting a variable indicating that the animation of the tile is ongoing). The process then activates (at 1860) the animation according to the previously defined animation instructions. The process animates the fade in of the building representations in 2D or 3D modes and in the 3D mode it animates the rising of the building representations while they fade in. The animation proceeds for the time and at the speeds defined in operation 1825 and steps the fade in and rising (3D mode only) as defined in operation 1835 (for 3D mode) or 1845 (for 2D mode).

In some embodiments the animation instructions are at least partly performed by a vertex shader that receives the variables for opacity and height and identifies the 2D locations of the vertices of the buildings. When the vertex shader of those embodiments is executed it receives an identification of a fraction (e.g., between 0 and 1, inclusive). The fraction represents the portion of the stored full height of the building representations in the tile at a given time. The fraction is determined by the amount of time the animation has been executing. The vertex shader adjusts the stored height of the building representations in the tile by a factor of that fraction so that the building will be drawn at the correct height at that time. The vertex shader also receives one or more color component values that include an opacity value for the pixels in the building representations. The vertex shader uses the changing opacity values to draw the building representations fading in. The vertex shader is called repeatedly by the process for each next fractional increase in the opacity and/or height of the building. In some embodiments, the vertex shader includes support for fog that partially or completely obscures distant building representations. In some embodiments, the fog is used to put a limit on the distance at which the building representations are displayed. This reduces the burden of displaying extremely distant building representations near the horizon of the 3D perspective map.

The map applications of some embodiments also use a fragment shader which computes the colors of each pixel in the image. The fragment shader is also provided with the opacity of the building and the fraction of the height of the buildings to be displayed. It takes these values and other variables relating to the lighting of the scene, fog, etc. to determine the color of each pixel of the image.

The process 1800 then activates (at 1865) the animation end instructions. The animation end occurs as defined by the instructions set in operation 1840 (for 3D) or operation 1850 (for 2D). In 3D mode the building representations are set to their full heights and full opacity, while in 2D mode the building representations are set to full opacity and zero height. In embodiments where the animation end instructions include an instruction to mark the animation as complete, the animation end marks the animation as complete (e.g., by overwriting the variable that marked animation as ongoing for the tile). In some embodiments, the process 1800 can be run for multiple tiles simultaneously (in parallel) or in an overlapping manner (rapidly in series) such that multiple tiles can be animated at the same time.

B. Lowering and Fade Out of Building Representations

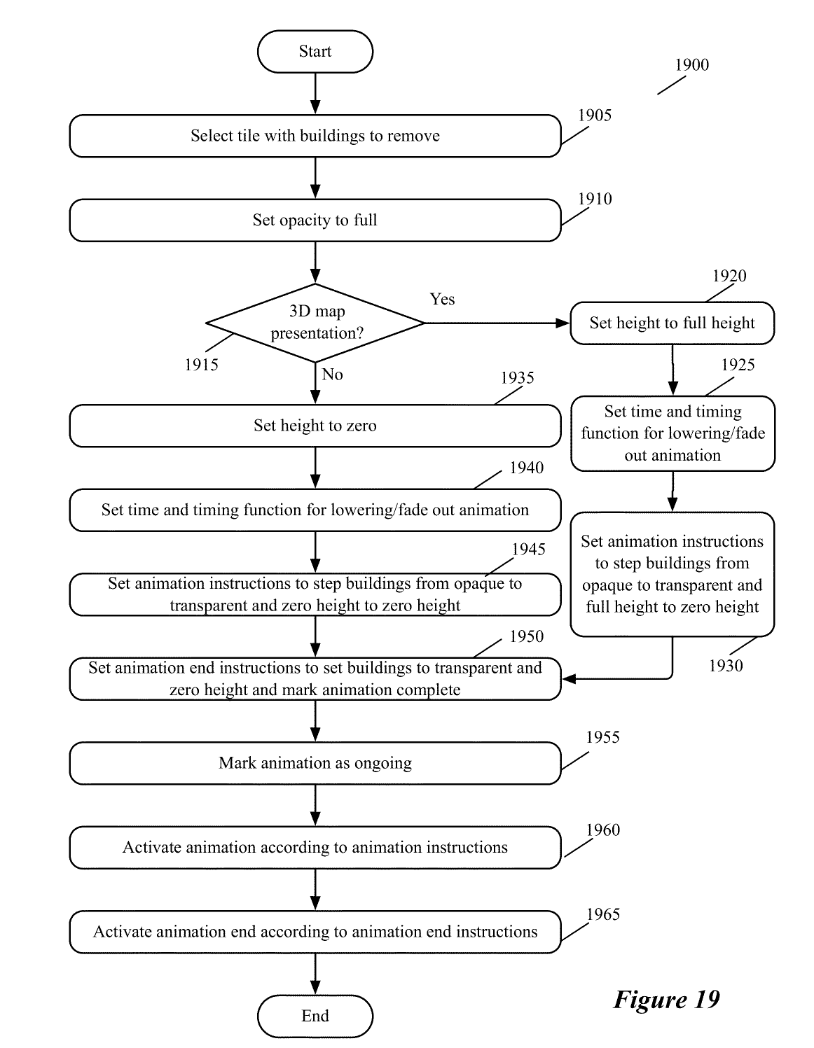

Just as some embodiments have a rise and fade in process for adding building representations to a map presentation, some embodiments have a lower and fade out process for removing building representations from a map presentation. The lower and fade out process of some embodiments provides directions for and animation of the lowering and fading out of the building representations. FIG. 19 illustrates a process 1900 of some embodiments for directing the animation of building representations being removed. The process selects (at 1905) a tile that contains building representations to be removed. As previously described with respect to FIGS. 12-17, this tile can be a tile in areas that the map presentation is shifted to, or tiles on a map presentation that is zoomed past (above) a threshold level. The tile could also be a tile that has a requirement for removing building representations for some other reason (e.g., rotation, tilting up to 2D mode, or raising the camera in 3D mode).

After identifying the tile, the process 1900 sets (at 1910) the opacities of the building representations in that tile to one. This allows the tile animation to start displaying the building from a completely opaque state. In some embodiments, either before or after operation 1910 (or at some other point in the lowering/fade out process), the process determines whether there is any ongoing animation of a building representation rising in the selected tile. In some such embodiments, the ongoing animation of the building representation fading in and/or rising is stopped before the animation of the building fading out and/or lowering is started.

The process 1900 then determines (at 1915) whether the map presentation is currently in a 3D mode or a 2D mode. When the map presentation is in a 3D mode, the process sets (at 1920) the height of the building representations in the selected tile to full height. The process 1900 then sets (at 1925) a duration and a timing function for lowering and fading out the building representations. The duration determines how long the eventual animation of the building representations lowering and fading out should take. The timing function determines how much of the height and opacity of the building representation will be removed at what times within the animation time. The simplest timing function, used by some embodiments, is a linear timing function from start to finish. When using such a linear timing function, the portion of the building that is removed is the same as the portion of the time completed. For example, if the duration is set to 0.8 seconds, then the linear timing function will have the building one quarter lowered and one quarter transparent (i.e., at three quarters height and three quarters opacity) at 0.2 seconds, half height and half opaque at 0.4 seconds, etc. In other embodiments, the map application uses a timing function that sets the animation to ease into the lowering and fading out and then go faster toward the end of the lower and fade out animation.

The process 1900 then sets (at 1930) animation instructions to step the building representations from opaque to transparent and from their full height to zero height. The animation instructions are set by operation 1930. However, the process 1900 does not perform the actual animation yet. The process then proceeds to operation 1950.

When the process determines (at 1915) that the map presentation is in a 2D mode, the process sets (at 1935) the height of the building representations in the selected tile to zero (2D). The process 1900 then sets (at 1940) a duration and a timing function for fading out the building representations. The duration determines how long the eventual animation of the building representations fading out should take. The timing function determines how much the building will be transparent at what times within the animation time. The simplest timing function, used by some embodiments, is a linear timing function from start to finish. When using such a linear timing function, the portion of the building's opacity that is removed is the same as the portion of the time completed. For example, if the duration is set to 0.8 seconds, then the linear timing function will have the building at one quarter transparent (i.e., at three quarters opacity) at 0.2 seconds, half opaque at 0.4 seconds, etc. In other embodiments, the map application uses a timing function that sets the animation to ease into the fading out and then go faster toward the end of the fade out animation.

The process 1900 then sets (at 1945) animation instructions to step the building representations from opaque to transparent and from their zero height to zero height (i.e., to keep the building representations flat). The animation instructions are set by operation 1945. However, the process 1900 does not perform the actual animation yet. The process then proceeds to operation 1950.

The process 1900 sets (at 1950) instructions for the end of the animation. The instructions for ending the animation include instructions to set the building representations to zero height and zero opacity (i.e., to not display the buildings). In some embodiments the end animation instructions include an instruction to set a variable indicating that the animation of the tile is complete (i.e., to mark the animation for the tile as being complete). In some embodiments, this variable is checked in operation 1815 of process 1800 of FIG. 18 to determine whether there is ongoing lowering/fade out animation for a tile selected by that operation.

The process 1900 marks (at 1955) the animation as ongoing (e.g., by setting a variable indicating that the lowering/fade out animation of the tile is ongoing). The process then activates (at 1960) the animation according to the previously defined animation instructions. The process animates the fade out of the building representations in 2D or 3D modes and in the 3D mode it animates the lowering of the building representations while they fade out. The animation proceeds for the time and at the speeds defined in operation 1925 and steps the fade out (2D or 3D modes) and rising (3D mode only) as defined in operation 1935 (for 3D mode) or 1945 (for 2D mode).

In some embodiments the animation instructions are at least partly performed by a vertex shader that receives the variables for opacity and height. In some embodiments, this is the same vertex shader used in animating the building rise and fade in process 1800. As described above with respect to FIG. 18, the map applications of some embodiments employ a fragment shader which computes the colors of each pixel in the image. The fragment shader is also provided with the opacity of the building and the fraction of the height of the buildings to be displayed. As described above, the fragment shader uses this data and other values such as scene lighting values and fog values to determine the color of each pixel in the image.

The process 1900 then activates (at 1965) the animation end instructions. The animation end occurs as defined by the instructions set in operation 1950. In both 3D mode and 2D mode the building representations are set to zero heights and zero opacity (i.e., the buildings are no longer displayed). In embodiments where the animation end instructions include an instruction to mark the animation as complete, the animation end marks the animation as complete (e.g., by overwriting the variable that marked animation as ongoing for the tile).

One of ordinary skill in the art will understand that in some embodiments, when raising and fading in 3d object representations, the 3D object representations will rise from almost their base (e.g., start at a short height rather than zero height) and/or rise toward a full height without reaching a full height in the animation (e.g., the object representations reach 85% or some other percentage of their full height then abruptly are displayed at full height). Similarly, in some embodiments, the 3D object representations will start out partly transparent instead of completely transparent and may transition to a partly opaque state rather than a fully opaque state. Furthermore the reverse holds true in some embodiments for lowering and fading out 3D object representations. The object representations may lower some amount abruptly, then lower some amount gradually before vanishing when they are at a low height, rather than at zero height. Similarly, the 3D object representations of some embodiments may transition from partly opaque to partly transparent before disappearing.

### IV. Software Architecture

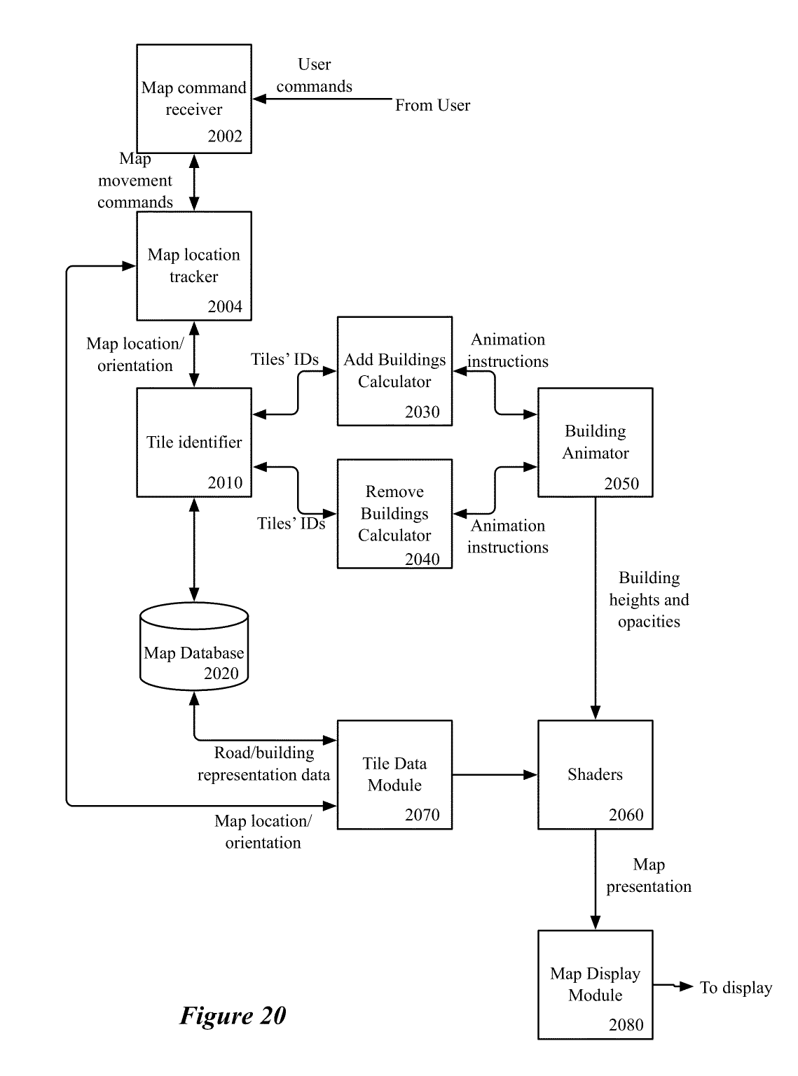

FIG. 20 conceptually illustrates a software architecture of part of a map application of some embodiments. The figure illustrates the part of the architecture that is concerned with rising/lowering and fading in/fading out building representation. One of ordinary skill in the art will understand that the map applications of some embodiments include other modules not covered in this figure. The figure includes map command receiver 2002, map location tracker 2004, tile identifier 2010, map database 2020, add buildings calculator 2030, remove buildings calculator 2040, building animator 2050, shaders 2060, tile data module 2070 and map display 2080.

The map command receiver 2002 receives user commands (e.g., zoom in, pan, rotate, tilt into 3D, etc.) and determines how to pass these commands to the map location tracker 2004. The map location tracker 2004 follows map movement commands and sends data on map location and orientation to the tile identifier 2010 and the tile data module 2070. Tile identifier 2010 identifies which tiles contain buildings to be added and which tiles contain buildings to be removed, it also retrieves information on the characteristics (e.g., height, shape) of buildings in those tiles from the map database 2020.

Map database 2020 stores data about the map. In some embodiments, the map data is stored in the form of tiles. The tile data in some embodiments includes data about roads and buildings among other types of data (e.g., data about parks, trees, etc.). The map database 2020 sends the data about the tiles to the tile identifier 2010 and the tile data module 2070. The add buildings calculator 2030 receives identifications of tiles with buildings to be added from the tile identifier 2010 and generates instructions for animating the addition of building representations to a map presentation. The add buildings calculator 2030 sends these instructions to the building animator 2050. The remove buildings calculator 2040 receives identifications of tiles with buildings to be removed from the tile identifier 2010 and generates instructions for animating the removal of building representations from a map presentation. The remove buildings calculator 2040 sends these instructions to the building animator 2050.

The building animator 2050 generates a series of values for the heights and opacities that change over time (e.g., increasing for tiles with buildings to be added and decreasing for tiles with buildings to be removed). The building animator passes these height and opacity values on to the shaders 2060 (e.g., vertex shaders and fragment shaders). The shaders 2060 receive data on the opacity and relative building heights of building representations on a select set of tiles from the building animator 2050. The shaders 2060 also receive data about all the tiles in the map presentation (e.g., road location and type data and the shapes and full heights of the building representations) from the tile data module 2070.

The tile data module 2070 receives data about the map location and orientation (in some embodiments this comprises data about the virtual camera location and orientation) and determines what tiles are visible in a map presentation with the given location and orientation of the map. The tile data module 2070 retrieves any tile data that it does not already have from the database 2020. In some embodiments, the database 2020 is an on board database of the device, in other embodiments it is an external database on a server apart from the device. In still other embodiments, the device keeps a local database of some tiles (e.g., tiles in the present map presentation), and retrieves tiles as needed from an external database on a server. The tile data module provides data on all tiles within the visible map presentation to the shaders 2060.

The shaders 2060 combine the data they receive and calculate a color for each pixel in the map presentation and pass the resulting map presentation to the map display module 2080. The map display module 2080 sends the calculated scene to an electronic display that displays the map presentation on the device.

The software architecture diagram of FIG. 20 is provided to conceptually illustrate some embodiments. One of ordinary skill in the art will realize that some embodiments use different modular setups that may combine multiple functions into one module though the figure shows multiple modules, and/or may split up functions that the figure ascribes to a single module into multiple modules, and/or may recombine the split up functions in various modules. Furthermore different connections may be made among these modules. For example, in some embodiments the building animator or the shaders retrieve data about buildings heights and shapes from the database rather than having that information provided to them by the modules shown in FIG. 20.

While many of the figures above contain flowcharts that show a particular order of operations, one of ordinary skill in the art will understand that these operations may be performed in a different order in some embodiments. Furthermore, one of ordinary skill in the art will understand that the flowcharts are conceptual illustrations and that in some embodiments multiple operation may be performed in a single step.

### V. Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

A. Mobile Device

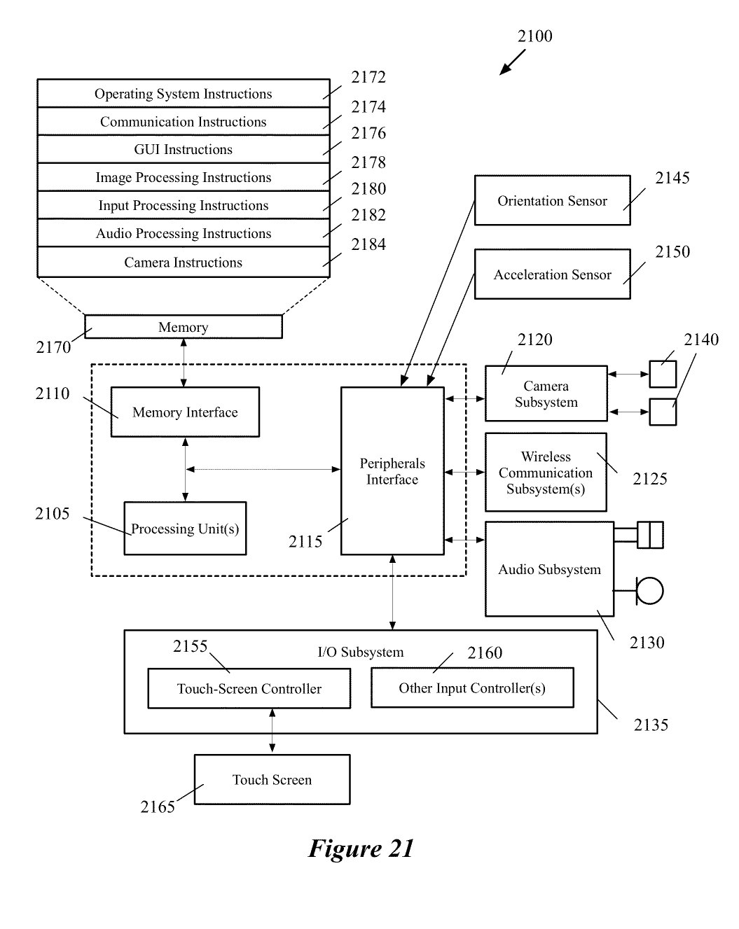

The mapping and navigation applications of some embodiments operate on mobile devices, such as smart phones (e.g., iPhones®) and tablets (e.g., iPads®). FIG. 21 is an example of an architecture 2100 of such a mobile computing device. Examples of mobile computing devices include smartphones, tablets, laptops, etc. As shown, the mobile computing device 2100 includes one or more processing units 2105, a memory interface 2110 and a peripherals interface 2115.

The peripherals interface 2115 is coupled to various sensors and subsystems, including a camera subsystem 2120, a wireless communication subsystem(s) 2125, an audio subsystem 2130, an I/O subsystem 2135, etc. The peripherals interface 2115 enables communication between the processing units 2105 and various peripherals. For example, an orientation sensor 2145 (e.g., a gyroscope) and an acceleration sensor 2150 (e.g., an accelerometer) is coupled to the peripherals interface 2115 to facilitate orientation and acceleration functions.

The camera subsystem 2120 is coupled to one or more optical sensors 2140 (e.g., a charged coupled device (CCD) optical sensor, a complementary metal-oxide-semiconductor (CMOS) optical sensor, etc.). The camera subsystem 2120 coupled with the optical sensors 2140 facilitates camera functions, such as image and/or video data capturing. The wireless communication subsystem 2125 serves to facilitate communication functions. In some embodiments, the wireless communication subsystem 2125 includes radio frequency receivers and transmitters, and optical receivers and transmitters (not shown in FIG. 21). These receivers and transmitters of some embodiments are implemented to operate over one or more communication networks such as a GSM network, a Wi-Fi network, a Bluetooth network, etc. The audio subsystem 2130 is coupled to a speaker to output audio (e.g., to output voice navigation instructions). Additionally, the audio subsystem 2130 is coupled to a microphone to facilitate voice-enabled functions, such as voice recognition (e.g., for searching), digital recording, etc.

The I/O subsystem 2135 involves the transfer between input/output peripheral devices, such as a display, a touch screen, etc., and the data bus of the processing units 2105 through the peripherals interface 2115. The I/O subsystem 2135 includes a touch-screen controller 2155 and other input controllers 2160 to facilitate the transfer between input/output peripheral devices and the data bus of the processing units 2105. As shown, the touch-screen controller 2155 is coupled to a touch screen 2165. The touch-screen controller 2155 detects contact and movement on the touch screen 2165 using any of multiple touch sensitivity technologies. The other input controllers 2160 are coupled to other input/control devices, such as one or more buttons. Some embodiments include a near-touch sensitive screen and a corresponding controller that can detect near-touch interactions instead of or in addition to touch interactions.

The memory interface 2110 is coupled to memory 2170. In some embodiments, the memory 2170 includes volatile memory (e.g., high-speed random access memory), non-volatile memory (e.g., flash memory), a combination of volatile and non-volatile memory, and/or any other type of memory. As illustrated in FIG. 21, the memory 2170 stores an operating system (OS) 2172. The OS 2172 includes instructions for handling basic system services and for performing hardware dependent tasks.

The memory 2170 also includes communication instructions 2174 to facilitate communicating with one or more additional devices; graphical user interface instructions 2176 to facilitate graphic user interface processing; image processing instructions 2178 to facilitate image-related processing and functions; input processing instructions 2180 to facilitate input-related (e.g., touch input) processes and functions; audio processing instructions 2182 to facilitate audio-related processes and functions; and camera instructions 2184 to facilitate camera-related processes and functions. The instructions described above are merely exemplary and the memory 2170 includes additional and/or other instructions in some embodiments. For instance, the memory for a smartphone may include phone instructions to facilitate phone-related processes and functions. Additionally, the memory may include instructions for a mapping and navigation application as well as other applications. The above-identified instructions need not be implemented as separate software programs or modules. Various functions of the mobile computing device can be implemented in hardware and/or in software, including in one or more signal processing and/or application specific integrated circuits.

While the components illustrated in FIG. 21 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 21 may be split into two or more integrated circuits.

B. Computer System

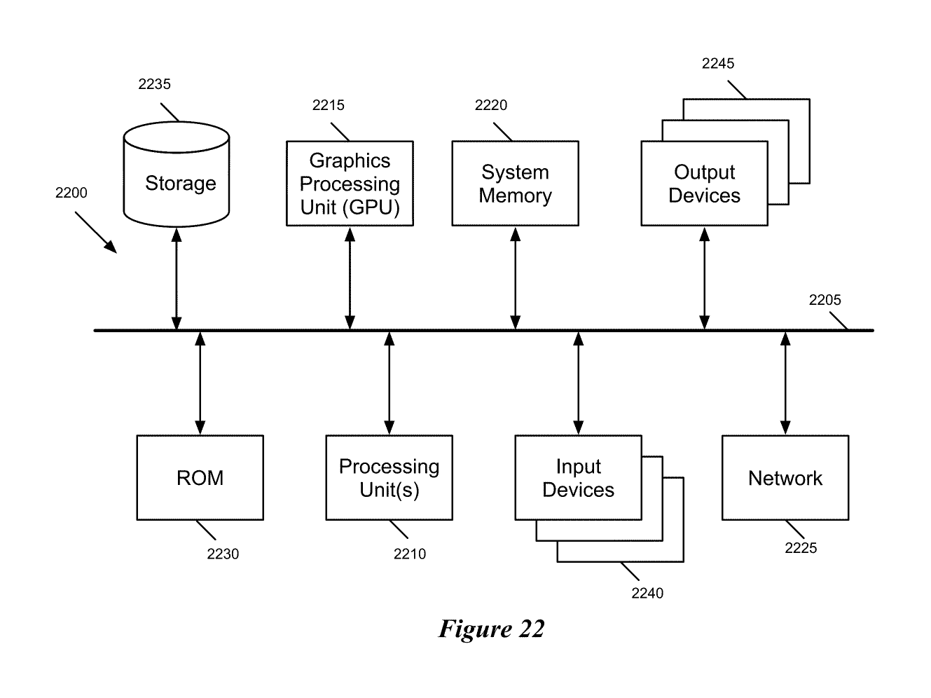

FIG. 22 conceptually illustrates another example of an electronic system 2200 with which some embodiments of the invention are implemented. The electronic system 2200 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 2200 includes a bus 2205, processing unit(s) 2210, a graphics processing unit (GPU) 2215, a system memory 2220, a network 2225, a read-only memory 2230, a permanent storage device 2235, input devices 2240, and output devices 2245.

The bus 2205 collectively represents all system, peripheral, and chipset buses that communicatively connect the numerous internal devices of the electronic system 2200. For instance, the bus 2205 communicatively connects the processing unit(s) 2210 with the read-only memory 2230, the GPU 2215, the system memory 2220, and the permanent storage device 2235.

From these various memory units, the processing unit(s) 2210 retrieves instructions to execute and data to process in order to execute the processes of the invention. The processing unit(s) may be a single processor or a multi-core processor in different embodiments. Some instructions are passed to and executed by the GPU 2215. The GPU 2215 can offload various computations or complement the image processing provided by the processing unit(s) 2210. In some embodiments, such functionality can be provided using CoreImage's kernel shading language.

The read-only-memory (ROM) 2230 stores static data and instructions that are needed by the processing unit(s) 2210 and other modules of the electronic system. The permanent storage device 2235, on the other hand, is a read-and-write memory device. This device is a non-volatile memory unit that stores instructions and data even when the electronic system 2200 is off. Some embodiments of the invention use a mass-storage device (such as a magnetic or optical disk and its corresponding disk drive, integrated flash memory) as the permanent storage device 2235.

Other embodiments use a removable storage device (such as a floppy disk, flash memory device, etc., and its corresponding drive) as the permanent storage device. Like the permanent storage device 2235, the system memory 2220 is a read-and-write memory device. However, unlike storage device 2235, the system memory 2220 is a volatile read-and-write memory, such a random access memory. The system memory 2220 stores some of the instructions and data that the processor needs at runtime. In some embodiments, the invention's processes are stored in the system memory 2220, the permanent storage device 2235, and/or the read-only memory 2230. For example, the various memory units include instructions for processing multimedia clips in accordance with some embodiments. From these various memory units, the processing unit(s) 2210 retrieves instructions to execute and data to process in order to execute the processes of some embodiments.

The bus 2205 also connects to the input and output devices 2240 and 2245. The input devices 2240 enable the user to communicate information and select commands to the electronic system. The input devices 2240 include alphanumeric keyboards and pointing devices (also called “cursor control devices”), cameras (e.g., webcams), microphones or similar devices for receiving voice commands, etc. The output devices 2245 display images generated by the electronic system or otherwise output data. The output devices 2245 include printers and display devices, such as cathode ray tubes (CRT) or liquid crystal displays (LCD), as well as speakers or similar audio output devices. Some embodiments include devices such as a touch screen that function as both input and output devices.

Finally, as shown in FIG. 22, bus 2205 also couples electronic system 2200 to a network 2225 through a network adapter (not shown). In this manner, the computer can be a part of a network of computers (such as a local area network (“LAN”), a wide area network (“WAN”), or an Intranet, or a network of networks, such as the Internet. Any or all components of electronic system 2200 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

### VI. Map Service Environment

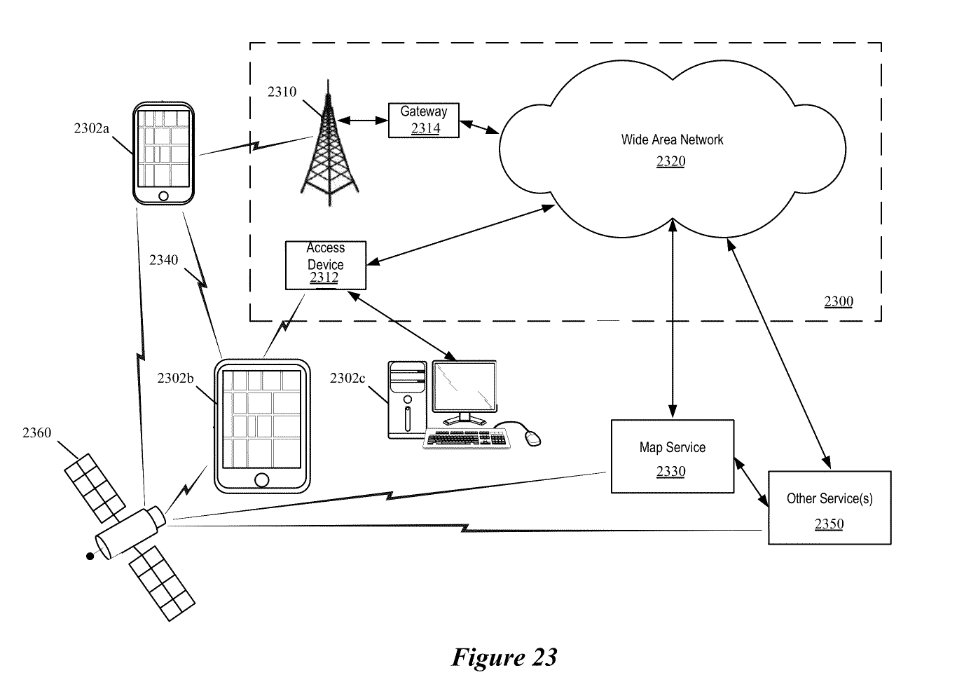

Various embodiments may operate within a map service operating environment. FIG. 23 illustrates a map service operating environment, according to some embodiments. A map service 2330 (also referred to as mapping service) may provide map services for one or more client devices 2302a-2302c in communication with the map service 2330 through various communication methods and protocols. A map service 2330 in some embodiments provides map information and other map-related data, such as two-dimensional map image data (e.g., aerial view of roads utilizing satellite imagery), three-dimensional map image data (e.g., traversable map with three-dimensional features, such as buildings), route and direction calculation (e.g., ferry route calculations or directions between two points for a pedestrian), real-time navigation data (e.g., turn-by-turn visual navigation data in two or three dimensions), location data (e.g., where is the client device currently located), and other geographic data (e.g., wireless network coverage, weather, traffic information, or nearby points-of-interest). In various embodiments, the map service data may include localized labels for different countries or regions; localized labels may be utilized to present map labels (e.g., street names, city names, points of interest) in different languages on client devices. Client devices 2302a-2302c may utilize these map services by obtaining map service data. Client devices 2302a-2302c may implement various techniques to process map service data. Client devices 2302a-2302c may then provide map services to various entities, including, but not limited to, users, internal software or hardware modules, and/or other systems or devices external to the client devices 2302a-2302c.

In some embodiments, a map service is implemented by one or more nodes in a distributed computing system. Each node may be assigned one or more services or components of a map service. Some nodes may be assigned the same map service or component of a map service. A load balancing node in some embodiments distributes access or requests to other nodes within a map service. In some embodiments a map service is implemented as a single system, such as a single server. Different modules or hardware devices within a server may implement one or more of the various services provided by a map service.

A map service in some embodiments provides map services by generating map service data in various formats. In some embodiments, one format of map service data is map image data. Map image data provides image data to a client device so that the client device may process the image data (e.g., rendering and/or displaying the image data as a two-dimensional or three-dimensional map). Map image data, whether in two or three dimensions, may specify one or more map tiles. A map tile may be a portion of a larger map image. Assembling together the map tiles of a map produces the original map. Tiles may be generated from map image data, routing or navigation data, or any other map service data. In some embodiments map tiles are raster-based map tiles, with tile sizes ranging from any size both larger and smaller than a commonly-used 256 pixel by 256 pixel tile. Raster-based map tiles may be encoded in any number of standard digital image representations including, but not limited to, Bitmap (.bmp), Graphics Interchange Format (.gif), Joint Photographic Experts Group (.jpg, .jpeg, etc.), Portable Networks Graphic (.png), or Tagged Image File Format (.tiff). In some embodiments, map tiles are vector-based map tiles, encoded using vector graphics, including, but not limited to, Scalable Vector Graphics (.svg) or a Drawing File (.drw). Some embodiments also include tiles with a combination of vector and raster data. Metadata or other information pertaining to the map tile may also be included within or along with a map tile, providing further map service data to a client device. In various embodiments, a map tile is encoded for transport utilizing various standards and/or protocols, some of which are described in examples below.

In various embodiments, map tiles may be constructed from image data of different resolutions depending on zoom level. For instance, for low zoom level (e.g., world or globe view), the resolution of map or image data need not be as high relative to the resolution at a high zoom level (e.g., city or street level). For example, when in a globe view, there may be no need to render street level artifacts as such objects would be so small as to be negligible in many cases.

A map service in some embodiments performs various techniques to analyze a map tile before encoding the tile for transport. This analysis may optimize map service performance for both client devices and a map service. In some embodiments map tiles are analyzed for complexity, according to vector-based graphic techniques, and constructed utilizing complex and non-complex layers. Map tiles may also be analyzed for common image data or patterns that may be rendered as image textures and constructed by relying on image masks. In some embodiments, raster-based image data in a map tile contains certain mask values, which are associated with one or more textures. Some embodiments also analyze map tiles for specified features that may be associated with certain map styles that contain style identifiers.

Other map services generate map service data relying upon various data formats separate from a map tile in some embodiments. For instance, map services that provide location data may utilize data formats conforming to location service protocols, such as, but not limited to, Radio Resource Location services Protocol (RRLP), TIA 801 for Code Division Multiple Access (CDMA), Radio Resource Control (RRC) position protocol, or LTE Positioning Protocol (LPP). Embodiments may also receive or request data from client devices identifying device capabilities or attributes (e.g., hardware specifications or operating system version) or communication capabilities (e.g., device communication bandwidth as determined by wireless signal strength or wire or wireless network type).

A map service may obtain map service data from internal or external sources. For example, satellite imagery used in map image data may be obtained from external services, or internal systems, storage devices, or nodes. Other examples may include, but are not limited to, GPS assistance servers, wireless network coverage databases, business or personal directories, weather data, government information (e.g., construction updates or road name changes), or traffic reports. Some embodiments of a map service may update map service data (e.g., wireless network coverage) for analyzing future requests from client devices.

Various embodiments of a map service may respond to client device requests for map services. These requests may be a request for a specific map or portion of a map. Some embodiments format requests for a map as requests for certain map tiles. In some embodiments, requests also supply the map service with starting locations (or current locations) and destination locations for a route calculation. A client device may also request map service rendering information, such as map textures or style sheets. In at least some embodiments, requests are also one of a series of requests implementing turn-by-turn navigation. Requests for other geographic data may include, but are not limited to, current location, wireless network coverage, weather, traffic information, or nearby points-of-interest.

A map service, in some embodiments, analyzes client device requests to optimize a device or map service operation. For instance, a map service may recognize that the location of a client device is in an area of poor communications (e.g., weak wireless signal) and send more map service data to supply a client device in the event of loss in communication or send instructions to utilize different client hardware (e.g., orientation sensors) or software (e.g., utilize wireless location services or Wi-Fi positioning instead of GPS-based services). In another example, a map service may analyze a client device request for vector-based map image data and determine that raster-based map data better optimizes the map image data according to the image's complexity. Embodiments of other map services may perform similar analysis on client device requests and as such the above examples are not intended to be limiting.

Various embodiments of client devices (e.g., client devices 2302a-2302c) are implemented on different portable-multifunction device types. Client devices 2302a-2302c utilize map service 2330 through various communication methods and protocols. In some embodiments, client devices 2302a-2302c obtain map service data from map service 2330. Client devices 2302a-2302c request or receive map service data. Client devices 2302a-2302c then process map service data (e.g., render and/or display the data) and may send the data to another software or hardware module on the device or to an external device or system.

A client device, according to some embodiments, implements techniques to render and/or display maps. These maps may be requested or received in various formats, such as map tiles described above. A client device may render a map in two-dimensional or three-dimensional views. Some embodiments of a client device display a rendered map and allow a user, system, or device providing input to manipulate a virtual camera in the map, changing the map display according to the virtual camera's position, orientation, and field-of-view. Various forms and input devices are implemented to manipulate a virtual camera. In some embodiments, touch input, through certain single or combination gestures (e.g., touch-and-hold or a swipe) manipulate the virtual camera. Other embodiments allow manipulation of the device's physical location to manipulate a virtual camera. For instance, a client device may be tilted up from its current position to manipulate the virtual camera to rotate up. In another example, a client device may be tilted forward from its current position to move the virtual camera forward. Other input devices to the client device may be implemented including, but not limited to, auditory input (e.g., spoken words), a physical keyboard, mouse, and/or a joystick.

Some embodiments provide various visual feedback to virtual camera manipulations, such as displaying an animation of possible virtual camera manipulations when transitioning from two-dimensional map views to three-dimensional map views. Some embodiments also allow input to select a map feature or object (e.g., a building) and highlight the object, producing a blur effect that maintains the virtual camera's perception of three-dimensional space.

In some embodiments, a client device implements a navigation system (e.g., turn-by-turn navigation). A navigation system provides directions or route information, which may be displayed to a user. Some embodiments of a client device request directions or a route calculation from a map service. A client device may receive map image data and route data from a map service. In some embodiments, a client device implements a turn-by-turn navigation system, which provides real-time route and direction information based upon location information and route information received from a map service and/or other location system, such as Global Positioning Satellite (GPS). A client device may display map image data that reflects the current location of the client device and update the map image data in real-time. A navigation system may provide auditory or visual directions to follow a certain route.

A virtual camera is implemented to manipulate navigation map data according to some embodiments. Some embodiments of client devices allow the device to adjust the virtual camera display orientation to bias toward the route destination. Some embodiments also allow virtual camera to navigation turns simulating the inertial motion of the virtual camera.

Client devices implement various techniques to utilize map service data from map service. Some embodiments implement some techniques to optimize rendering of two-dimensional and three-dimensional map image data. In some embodiments, a client device locally stores rendering information. For instance, a client stores a style sheet which provides rendering directions for image data containing style identifiers. In another example, common image textures may be stored to decrease the amount of map image data transferred from a map service. Client devices in different embodiments implement various modeling techniques to render two-dimensional and three-dimensional map image data, examples of which include, but are not limited to: generating three-dimensional buildings out of two-dimensional building footprint data; modeling two-dimensional and three-dimensional map objects to determine the client device communication environment; generating models to determine whether map labels are seen from a certain virtual camera position; and generating models to smooth transitions between map image data. Some embodiments of client devices also order or prioritize map service data in certain techniques. For instance, a client device detects the motion or velocity of a virtual camera, which if exceeding certain threshold values, lower-detail image data is loaded and rendered of certain areas. Other examples include: rendering vector-based curves as a series of points, preloading map image data for areas of poor communication with a map service, adapting textures based on display zoom level, or rendering map image data according to complexity.

In some embodiments, client devices communicate utilizing various data formats separate from a map tile. For instance, some client devices implement Assisted Global Positioning Satellites (A-GPS) and communicate with location services that utilize data formats conforming to location service protocols, such as, but not limited to, Radio Resource Location services Protocol (RRLP), TIA 801 for Code Division Multiple Access (CDMA), Radio Resource Control (RRC) position protocol, or LTE Positioning Protocol (LPP). Client devices may also receive GPS signals directly. Embodiments may also send data, with or without solicitation from a map service, identifying the client device's capabilities or attributes (e.g., hardware specifications or operating system version) or communication capabilities (e.g., device communication bandwidth as determined by wireless signal strength or wire or wireless network type).

FIG. 23 illustrates one possible embodiment of an operating environment 2300 for a map service 2330 and client devices 2302a-2302c. In some embodiments, devices 2302a, 2302b, and 2302c communicate over one or more wire or wireless networks 2310. For example, wireless network 2310, such as a cellular network, can communicate with a wide area network (WAN) 2320, such as the Internet, by use of gateway 2314. A gateway 2314 in some embodiments provides a packet oriented mobile data service, such as General Packet Radio Service (GPRS), or other mobile data service allowing wireless networks to transmit data to other networks, such as wide area network 2320. Likewise, access device 2312 (e.g., IEEE 802.11g wireless access device) provides communication access to WAN 2320. Devices 2302a and 2302b can be any portable electronic or computing device capable of communicating with a map service. Device 2302c can be any non-portable electronic or computing device capable of communicating with a map service.

In some embodiments, both voice and data communications are established over wireless network 2310 and access device 2312. For instance, device 2302a can place and receive phone calls (e.g., using voice over Internet Protocol (VoIP) protocols), send and receive e-mail messages (e.g., using Simple Mail Transfer Protocol (SMTP) or Post Office Protocol 3 (POP3)), and retrieve electronic documents and/or streams, such as web pages, photographs, and videos, over wireless network 2310, gateway 2314, and WAN 2320 (e.g., using Transmission Control Protocol/Internet Protocol (TCP/IP) or User Datagram Protocol (UDP)). Likewise, in some implementations, devices 2302b and 2302c can place and receive phone calls, send and receive e-mail messages, and retrieve electronic documents over access device 2312 and WAN 2320. In various embodiments, any of the illustrated client device may communicate with map service 2330 and/or other service(s) 2350 using a persistent connection established in accordance with one or more security protocols, such as the Secure Sockets Layer (SSL) protocol or the Transport Layer Security (TLS) protocol.

Devices 2302a and 2302b can also establish communications by other means. For example, wireless device 2302a can communicate with other wireless devices (e.g., other devices 2302b, cell phones, etc.) over the wireless network 2310. Likewise devices 2302a and 2302b can establish peer-to-peer communications 2340 (e.g., a personal area network) by use of one or more communication subsystems, such as Bluetooth® communication from Bluetooth Special Interest Group, Inc. of Kirkland, Wash. Device 2302c can also establish peer to peer communications with devices 2302a or 2302b (not shown). Other communication protocols and topologies can also be implemented. Devices 2302a and 2302b may also receive Global Positioning Satellite (GPS) signals from GPS satellites 2360.

Devices 2302a, 2302b, and 2302c can communicate with map service 2330 over the one or more wire and/or wireless networks, 2310 or 2312. For instance, map service 2330 can provide a map service data to rendering devices 2302a, 2302b, and 2302c. Map service 2330 may also communicate with other services 2350 to obtain data to implement map services. Map service 2330 and other services 2350 may also receive GPS signals from GPS satellites 2360.

In various embodiments, map service 2330 and/or other service(s) 2350 are configured to process search requests from any of client devices. Search requests may include but are not limited to queries for business, address, residential locations, points of interest, or some combination thereof. Map service 2330 and/or other service(s) 2350 may be configured to return results related to a variety of parameters including but not limited to a location entered into an address bar or other text entry field (including abbreviations and/or other shorthand notation), a current map view (e.g., user may be viewing one location on the multifunction device while residing in another location), current location of the user (e.g., in cases where the current map view did not include search results), and the current route (if any). In various embodiments, these parameters may affect the composition of the search results (and/or the ordering of the search results) based on different priority weightings. In various embodiments, the search results that are returned may be a subset of results selected based on specific criteria include but not limited to a quantity of times the search result (e.g., a particular point of interest) has been requested, a measure of quality associated with the search result (e.g., highest user or editorial review rating), and/or the volume of reviews for the search results (e.g., the number of times the search result has been review or rated).

In various embodiments, map service 2330 and/or other service(s) 2350 are configured to provide auto-complete search results that are displayed on the client device, such as within the mapping application. For instance, auto-complete search results may populate a portion of the screen as the user enters one or more search keywords on the multifunction device. In some cases, this feature may save the user time as the desired search result may be displayed before the user enters the full search query. In various embodiments, the auto complete search results may be search results found by the client on the client device (e.g., bookmarks or contacts), search results found elsewhere (e.g., from the Internet) by map service 2330 and/or other service(s) 2350, and/or some combination thereof. As is the case with commands, any of the search queries may be entered by the user via voice or through typing. The multifunction device may be configured to display search results graphically within any of the map display described herein. For instance, a pin or other graphical indicator may specify locations of search results as points of interest. In various embodiments, responsive to a user selection of one of these points of interest (e.g., a touch selection, such as a tap), the multifunction device is configured to display additional information about the selected point of interest including but not limited to ratings, reviews or review snippets, hours of operation, store status (e.g., open for business, permanently closed, etc.), and/or images of a storefront for the point of interest. In various embodiments, any of this information may be displayed on a graphical information card that is displayed in response to the user's selection of the point of interest.

In various embodiments, map service 2330 and/or other service(s) 2350 provide one or more feedback mechanisms to receive feedback from client devices 2302a-2302c. For instance, client devices may provide feedback on search results to map service 2330 and/or other service(s) 2350 (e.g., feedback specifying ratings, reviews, temporary or permanent business closures, errors etc.); this feedback may be used to update information about points of interest in order to provide more accurate or more up-to-date search results in the future. In some embodiments, map service 2330 and/or other service(s) 2350 may provide testing information to the client device (e.g., an A/B test) to determine which search results are best. For instance, at random intervals, the client device may receive and present two search results to a user and allow the user to indicate the best result. The client device may report the test results to map service 2330 and/or other service(s) 2350 to improve future search results based on the chosen testing technique, such as an A/B test technique in which a baseline control sample is compared to a variety of single-variable test samples in order to improve results.

While the invention has been described with reference to numerous specific details, one of ordinary skill in the art will recognize that the invention can be embodied in other specific forms without departing from the spirit of the invention. For instance, many of the figures illustrate various touch gestures (e.g., taps, double taps, swipe gestures, press and hold gestures, etc.). However, many of the illustrated operations could be performed via different touch gestures (e.g., a swipe instead of a tap, a tap of an on-screen control instead of a dragging gesture, etc.) or by non-touch input (e.g., using a cursor controller, a keyboard, a touchpad/trackpad, a near-touch sensitive screen, etc.). In addition, a number of the figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process.

What is claimed is:

1. A machine readable medium storing a mapping program for execution by at least one processing unit, the program comprising sets of instructions for:
providing at least one map presentation comprising a plurality of tiles during an operational mode of the mapping program;
identifying a tile of the plurality of tiles that contains data comprising an undisplayed three-dimensional (3D) object representation;
generating a set of animation instructions for displaying the 3D object representation, the set of animation instructions comprising instructions to raise the 3D object representation from a base level to a full height while increasing an opacity of the 3D object representation; and
displaying the 3D object representation according to the set of animation instructions.

2. The machine readable medium of claim 1, wherein the mapping program further comprises a set of instructions for setting a duration for applying the animation instructions.

3. The machine readable medium of claim 1, wherein the mapping program further comprises a set of instructions for setting a timing curve for applying the animation instructions, wherein the timing curve instructs that the 3D object representation be raised at a first rate for a first time period then raised at a second rate for a second time period, wherein the second rate is faster than the first rate.

4. The machine readable medium of claim 1, wherein the identified tile is a first tile of the plurality of tiles, the set of animation instructions is a first set of animation instructions, the 3D object representation is a first 3D object representation, the base level is a first base level, the full height is a first full height, and the opacity is a first opacity, the mapping program further comprises sets of instructions for:
identifying a second tile of the plurality of tiles that contains data comprising a displayed second 3D object representation;
generating a second set of animation instructions for ceasing to display the second 3D object representation, the second set of animation instructions comprising instructions to lower the second 3D object representation from a second full height to a second base level while decreasing a second opacity of the second 3D object representation;
displaying the second 3D object representation according to the second set of animation instructions.

5. The machine readable medium of claim 4, wherein lowering the second 3D object representation comprises sequentially removing levels of the second 3D object representation from a top down.

6. The machine readable medium of claim 1, wherein the 3D object representations comprise 3D representations of buildings.

7. A method of displaying 3D object representations on a map displayed on an electronic device, the method comprising:
receiving a command to shift a displayed map to display a new area;
shifting the map to display the new area; and
in the new area, displaying the three-dimensional (3D) object representations by gradually raising the representations from a base level to a full height and causing the representations to gradually transition from transparent to opaque.

8. The method of claim 7, wherein the full height is different for different 3D object representations.

9. The method of claim 7, wherein each of a plurality of 3D object representations grows at a particular speed.

10. The method of claim 7, wherein each of a plurality of 3D object representations grows at a speed proportional to the full height of the 3D object representations.

11. The method of claim 7, wherein the transition of the 3D object representations from transparent to opaque starts at the same time as the raising of the 3D object representations from the base level.

12. The method of claim 7, wherein the transition of the 3D object representations from transparent to opaque starts before the raising of the 3D object representations from the base level.

13. A method of displaying three-dimensional (3D) object representations on a map displayed on an electronic device, the method comprising:
receiving a command to shift a displayed map to display a new area;
shifting the map to display the new area; and
in a previously displayed area of the map, displaying the 3D object representations as gradually lowering to a base level from a full height and gradually transitioning from opaque to transparent.

14. The method of claim 13, wherein the 3D object representations being lowered are beyond a threshold distance from the center of the displayed map.

15. The method of claim 13, wherein the previously displayed area of the map is a first previously displayed area of the map and the 3D object representations are a first set of 3D object representations, the method further comprising displaying a second set of 3D object representations in a second previously displayed area of the map without lowering the second set of 3D object representations and transitioning the second set of 3D object representations from opaque to transparent.

16. The method of claim 15 further comprising displaying in the new area, a third set of 3D object representations by gradually raising the third set of 3D object representations from a base level to a full height and causing the third set of 3D object representations to gradually transition from transparent to opaque.

17. A method of displaying three-dimensional (3D) object representations on a map displayed on an electronic device, the method comprising:
receiving a command to zoom in on the map past a threshold zoom level;
zooming in on the map past the threshold zoom level; and
from the map, gradually raising a plurality of the 3D object representations from a base level and causing the representations to gradually transition from transparent to opaque.

18. The method of claim 17 further comprising:
while raising the representations and transitioning the representations from transparent to opaque, receiving a command to zoom out past the threshold level;
zooming the map out;
stopping the raising of the representations at a particular set of heights and stopping the transition of the representation from transparent to opaque at a particular level of opacity;
lowering the representations from the particular set of heights to a base level; and
transitioning the representations from the particular level of opacity to transparent.

19. The method of claim 17, wherein the transition of the 3D object representations from transparent to opaque starts at the same time as the raising of the 3D object representations from the base level.

20. The method of claim 17, wherein the transition of the 3D object representations from transparent to opaque starts before the raising of the 3D object representations from the base level.

21. A method of displaying three-dimensional (3D) object representations on a map displayed on an electronic device, the method comprising:
receiving a command to zoom out on the map past a threshold zoom level;
zooming out on the map past the threshold zoom level; and
from the map, gradually lowering a plurality of the 3D object representations to a base level and causing the representations to gradually transition from opaque to transparent.

22. The method of claim 21, wherein the plurality of 3D object representations comprises a first set of representations visible in an area of the map that is displayed before the zooming out, and a second set of representations visible in an area of the map that is not displayed before the zooming out.

23. The method of claim 21 further comprising:
while lowering the representations and transitioning the representations from opaque to transparent, receiving a command to zoom in past the threshold level;
zooming in on the map;
stopping the lowering of the representations at a particular set of heights and stopping the transition of the representation from opaque to transparent at a particular level of opacity;
raising the representations from the particular set of heights to a set of full heights; and
transitioning the representations from the particular level of opacity to opaque.

24. A method of displaying three-dimensional (3D) object representations on a map displayed on an electronic device, the method comprising:
in a two dimensional mode of the map, receiving a command to zoom in on the map past a threshold zoom level;
zooming in on the map past the threshold zoom level;
gradually transitioning, from transparent to opaque, a plurality of two-dimensional (2D) object representations on the map;
receiving a command to display the map in a three dimensional mode;
displaying the map in a three dimensional mode; and
gradually raising the plurality of 2D object representations on the map to 3D object representations.

25. The method of claim 24, wherein the command to display the map in three dimensions is received when the plurality of 2D object representations has transitioned to a particular opacity level, the method further comprising, while gradually raising the plurality of 2D object representations on the map to 3D object representations, transitioning the 3D object representations from the particular opacity level to opaque.

26. The method of claim 24, wherein the command to display the map in three dimensions is received after the plurality of 2D object representations has transitioned to being opaque.
